(19) United States
(12) Patent Application Publication
(10) Pub. No.: US 2026/0113430 A1
(43) Pub. Date: Apr. 23, 2026

(54) DECODER SIDE MOTION REFINEMENT FOR UNI-PREDICTION

(71) Applicant: Alibaba (China) Co., Ltd., Hangzhou (CN)

(72) Inventors: Jie CHEN, Beijing (CN); Ru-ling LIAO, Sunnyvale, CA (US); Yan YE, San Diego, CA (US); Xinwei LI, Beijing (CN)

(21) Appl. No.: 19/349,361

(22) Filed: Oct. 3, 2025

Related U.S. Application Data
(60) Provisional application No. 63/709,589, filed on Oct. 21, 2024.
(60) Provisional application No. 63/853,673, filed on Jul. 30, 2025.

(51) Int. Cl. H04N 19/105; H04N 19/137

(52) U.S. Cl. CPC H04N 19/105; H04N 19/137

(57) ABSTRACT

A method of decoding a bitstream to output one or more pictures for a video stream includes: decoding a bitstream to construct a merge candidate list including one or more merge candidates; determining whether a first candidate from the merge candidate list is a uni-motion candidate; in response to the first candidate being the uni-motion candidate, determining a bi-motion candidate based on the first candidate and one or more candidate motion vectors; and adding the bi-motion candidate to the merge candidate list.

### CROSS-REFERENCE TO RELATED APPLICATIONS

This application claims priority to U.S. Provisional Application No. 63/709,589, titled “DECODER SIDE MOTION REFINEMENT FOR UNI-PREDICTION,” filed on Oct. 21, 2024, and U.S. Provisional Application No. 63/853,673, titled “DECODER SIDE MOTION REFINEMENT FOR UNI-PREDICTION,” filed on Jul. 30, 2025, both of which are hereby incorporated by reference in their entireties.

### TECHNICAL FIELD

The present disclosure generally relates to video processing, and more particularly, to methods and apparatuses for decoder side motion refinement for uni-prediction.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards gets higher and higher.

### SUMMARY

Embodiments of the present disclosure provide methods and apparatuses for decoder side motion refinement for uni-prediction.

According to some embodiments, a method of decoding a bitstream to output one or more pictures for a video stream includes: decoding a bitstream to construct a merge candidate list including one or more merge candidates; determining whether a first candidate from the merge candidate list is a uni-motion candidate; in response to the first candidate being the uni-motion candidate, determining a bi-motion candidate based on the first candidate and one or more candidate motion vectors; and adding the bi-motion candidate to the merge candidate list.

According to some embodiments, a method of encoding a video sequence into a bitstream includes: receiving a video sequence and encoding one or more pictures of the video sequence to generate a bitstream. The encoding includes: constructing a merge candidate list including one or more merge candidates; determining whether a first candidate from the merge candidate list is a uni-motion candidate; and in response to the candidate being the uni-motion candidate, determining a bi-motion candidate based on the first candidate and one or more candidate motion vectors; and adding the bi-motion candidate to the merge candidate list.

According to some embodiments, a method for storing a bitstream includes constructing a merge candidate list including one or more merge candidates, updating the constructed merge candidate list, generating a bitstream including coded information of the updated merge candidate list, and storing the bitstream in a non-transitory computer-readable medium. The updating the constructed merge candidate list includes: determining whether a first candidate from the constructed merge candidate list is a uni-motion candidate; in response to the candidate being the uni-motion candidate, determining a bi-motion candidate based on the first candidate and one or more candidate motion vectors; and adding the bi-motion candidate to the merge candidate list.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates structures of an example video sequence, according to some embodiments of the present disclosure.

FIG. 2 illustrates a schematic diagram of an example encoder of a video coding system, according to some embodiments of the present disclosure.

FIG. 3 illustrates a block diagram of an example decoder of a video coding system, according to some embodiments of the present disclosure.

FIG. 4 is a block diagram of an example apparatus for encoding or decoding a video, according to some embodiments of the present disclosure.

FIG. 5 is a schematic diagram illustrating example positions of spatial merge candidate, according to some embodiments of the present disclosure.

FIG. 6 is a schematic diagram illustrating example candidate pairs considered for redundancy check of spatial merge candidates, according to some embodiments of the present disclosure.

FIG. 7 is a schematic diagram illustrating example motion vector scaling for temporal merge candidate, according to some embodiments of the present disclosure.

FIG. 8A is a schematic diagram illustrating example candidate positions for temporal merge candidate, according to some embodiments of the present disclosure.

FIG. 8B is a schematic diagram illustrating example subblock templates generation of subblock-based temporal motion vector prediction (SbTMVP), according to some embodiments of the present disclosure.

FIG. 9 is a schematic diagram illustrating example spatial neighboring blocks used to derive the spatial merge candidates, according to some embodiments of the present disclosure.

FIG. 10 illustrates an example decoding side motion vector refinement (DMVR) process, according to some embodiments of the present disclosure.

FIG. 11 illustrates an example 3×3 square search pattern for the first pass in the MP-DMVR, according to some embodiments of the present disclosure.

FIG. 12 illustrates an example of diamond regions in the search area for the second pass in the MP-DMVR, according to some embodiments of the present disclosure.

FIG. 13 illustrates an example template matching process performed on a search area around initial MV, according to some embodiments of the present disclosure.

FIG. 14A and FIG. 14B illustrate example diamond search patterns, according to some embodiments of the present disclosure.

FIG. 15 is a flowchart of a template-based refinement process for bi-prediction coding blocks, according to some embodiments of the present disclosure.

FIG. 16A and FIG. 16B are two schematic diagrams illustrating control-points-based affine model for blocks, according to some embodiments of the present disclosure.

FIG. 17 is a schematic diagram illustrating motion vector of the center sample of each subblock of a block, according to some embodiments of the present disclosure.

FIG. 18 illustrates control point motion vector inheritance, according to some embodiments of the present disclosure.

FIG. 19A and FIG. 19B illustrate spatial neighbors for deriving affine merge and affine advanced motion vector prediction (AMVP) candidates, according to some embodiments of the present disclosure.

FIG. 20 illustrates locations of candidates position for constructed affine merge mode, according to some embodiments of the present disclosure.

FIG. 21 illustrates a first type of constructed affine merge/AMVP candidates, according to some embodiments of the present disclosure.

FIG. 22 illustrates neighboring subblocks being used for regression based affine merge candidate derivation, according to some embodiments of the present disclosure.

FIG. 23 illustrates subblock MV and pixel, according to some embodiments of the present disclosure.

FIG. 24 illustrates a template and reference samples of the template in reference pictures, according to some embodiments of the present disclosure.

FIG. 25 illustrates a template and reference samples of the template for block with subblock motion, according to some embodiments of the present disclosure.

FIG. 26 is a flowchart of a template-based reordering and template-based motion refinement process, according to some embodiments of the present disclosure.

FIGS. 27A-27D are flowcharts of example processes of merge candidate list conversion, according to some embodiments of the present disclosure.

FIG. 28 is a flowchart of an example conversion process to convert a uni-motion candidate to a bi-motion candidate, according to some embodiments of the present disclosure.

FIG. 29A is a schematic diagram illustrating an example merge candidate list, according to some embodiments of the present disclosure.

FIGS. 29B-29G are schematic diagrams illustrating examples of merge candidate list conversion corresponding to the processes in FIGS. 27A-27D, according to some embodiments of the present disclosure.

FIG. 30 is a flowchart of an example conversion process to convert a uni-motion candidate to a bi-motion candidate, according to some embodiments of the present disclosure.

FIG. 31 is a flowchart of an example conversion process to convert a uni-motion candidate to a bi-motion candidate, according to some embodiments of the present disclosure.

FIG. 32A illustrates an integer template matching (TM) search process, according to some embodiments of the present disclosure.

FIG. 32B illustrates a half-pixel TM search process, according to some embodiments of the present disclosure.

FIG. 33 is a flowchart of an example merge candidate conversion process, according to some embodiments of the present disclosure.

FIG. 34 is a flowchart of an example process of merge candidate list conversion, according to some embodiments of the present disclosure.

FIGS. 35A-35B are schematic diagrams illustrating example MV of sub-template of an affine motion codec block, according to some embodiments of the present disclosure.

FIG. 36 is a flowchart of an example video decoding method, according to some embodiments of the present disclosure.

FIG. 37 is a flowchart for an example video encoding method for encoding a bitstream, according to some embodiments of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve this goal, since 2015, the JVET has been developing technologies beyond HEVC using the joint exploration model (JEM) reference software. As coding technologies being incorporated into the JEM, the JEM achieved substantially higher coding performance than HEVC. In October 2017, a joint call for proposals (CfP) was issued by VCEG and MPEG to formally start the development of next generation video compression standard beyond HEVC. Responses to the CfP were evaluated at the JVET meeting in San Diego in April 2018, and the formal development process of the VVC standard started in April 2018.

The VVC standard has been progressing well since April 2018, and continues to include more coding technologies that provide better compression performance. VVC is based on the same hybrid video coding system that has been used in modern video compression standards such as HEVC, H.264/AVC, MPEG2, H.263, etc. In July 2020, the first version of VVC standard is finalized and is published as an international standard. Afterward, the JVET starts exploring new coding tools to further improve the coding performance of the VVC standard. In January 2021, the Enhanced Compression Model (ECM) has been proposed and used as new software base for developing tools beyond the VVC standard.

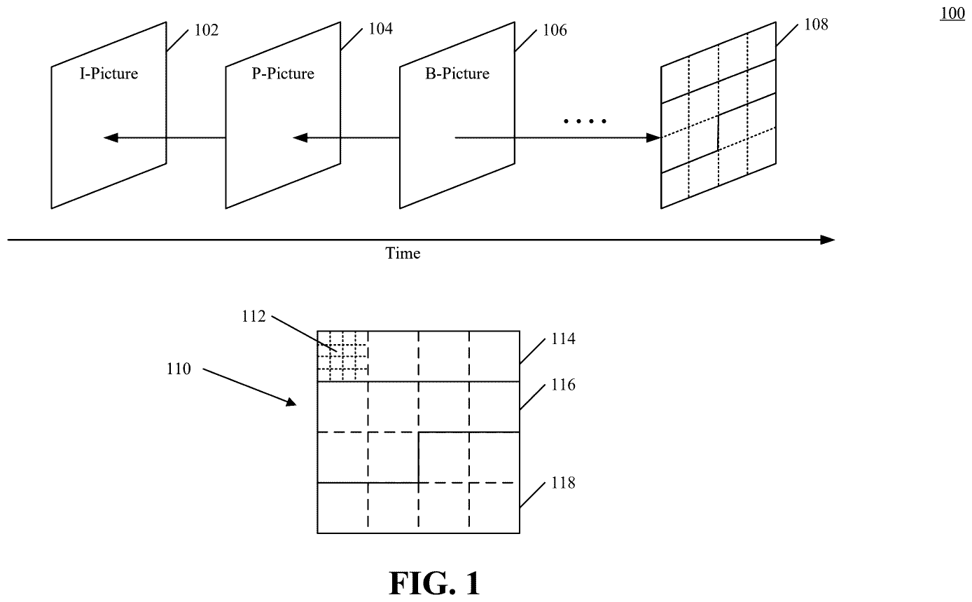

FIG. 1 illustrates structures of an example video sequence, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider. As shown in FIG. 1, video sequence 100 can include a series of pictures arranged temporally along a timeline, including pictures 102, 104, 106, and 108. Pictures 102-106 are continuous, and there are more pictures between pictures 106 and 108.

When a video is being compressed or decompressed, useful information of a picture being encoded (referred to as a “current picture”) include changes with respect to a reference picture (e.g., a picture previously encoded and reconstructed). Such changes can include position changes, luminosity changes, or color changes of the pixels. For example, position changes of a group of pixels can reflect the motion of an object represented by these pixels between two pictures (e.g., the reference picture and the current picture).

For example, as shown in FIG. 1, picture 102 is an I-picture, using itself as the reference picture. Picture 104 is a P-picture, using picture 102 as its reference picture, as indicated by the arrow. Picture 106 is a B-picture, using pictures 104 and 108 as its reference pictures, as indicated by the arrows. In some embodiments, the reference picture of a picture may be or may be not immediately preceding or following the picture. For example, the reference picture of picture 104 can be a picture preceding picture 102, i.e., a picture not immediately preceding picture 104. The above-described reference pictures of pictures 102-106 shown in FIG. 1 are merely examples, and not meant to limit the present disclosure.

Due to the computing complexity, in some embodiments, video codecs can split a picture into multiple basic segments and encode or decode the picture segment by segment. That is, video codecs do not necessarily encode or decode an entire picture at one time. Such basic segments are referred to as basic processing units (“BPUs”) in the present disclosure. For example, FIG. 1 also shows an example structure 110 of a picture of video sequence 100 (e.g., any of pictures 102-108). For example, structure 110 may be used to divide picture 108. As shown in FIG. 1, picture 108 is divided into 4×4 basic processing units. In some embodiments, the basic processing units can be referred to as “coding tree units” (“CTUs”) in some video coding standards (e.g., AVS3, H.265/HEVC or H.266/VVC), or as “macroblocks” in some video coding standards (e.g., MPEG family, H.261, H.263, or H.264/AVC). In AVS3 or VVC, a coded tree unit (CTU) can be the largest block unit, and can be as large as 128×128 luma samples (plus the corresponding chroma samples depending on the chroma format).

The basic processing units in FIG. 1 are for illustrative purpose only. The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards. Operations performed to a basic processing unit can be repeatedly performed to its luma and chroma components.

During multiple stages of operations in video coding, the size of the basic processing units may still be too large for processing, and thus can be further partitioned into segments referred to as “basic processing sub-units” in the present disclosure. For example, at a mode decision stage, the encoder can split the basic processing unit into multiple basic processing sub-units and decide a prediction type for each individual basic processing sub-unit. As shown in FIG. 1, basic processing unit 112 in structure 110 is further partitioned into 4×4 basic processing sub-units. For example, a coded tree unit CTU may be further partitioned into coding units (CUs) using quad-tree, binary tree, or extended binary tree. The basic processing sub-units in FIG. 1 is for illustrative purpose only. Different basic processing units of the same picture can be partitioned into basic processing sub-units in different schemes. The basic processing sub-units can be referred to as “coding units” (“CUs”) in some video coding standards (e.g., AVS3, H.265/HEVC or H.266/VVC), or as “blocks” in some video coding standards (e.g., MPEG family, H.261, H.263, or H.264/AVC). The size of a basic processing sub-unit can be the same or smaller than the size of a basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Operations performed to a basic processing sub-unit can be repeatedly performed to its luma and chroma components. Such division can be performed to further levels depending on processing needs, and in different stages, the basic processing units can be partitioned using different schemes. At the leaf nodes of the partitioning structure, coding information such as coding mode (e.g., intra prediction mode or inter prediction mode), motion information (e.g., reference index, motion vectors (MVs), etc.) required for corresponding coding mode, and quantized residual coefficients are sent.

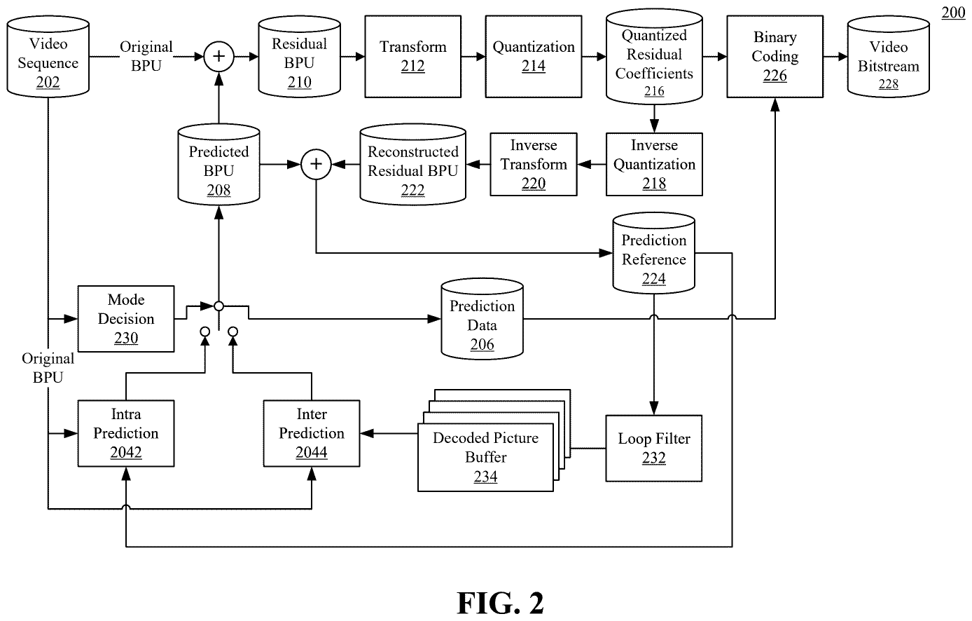

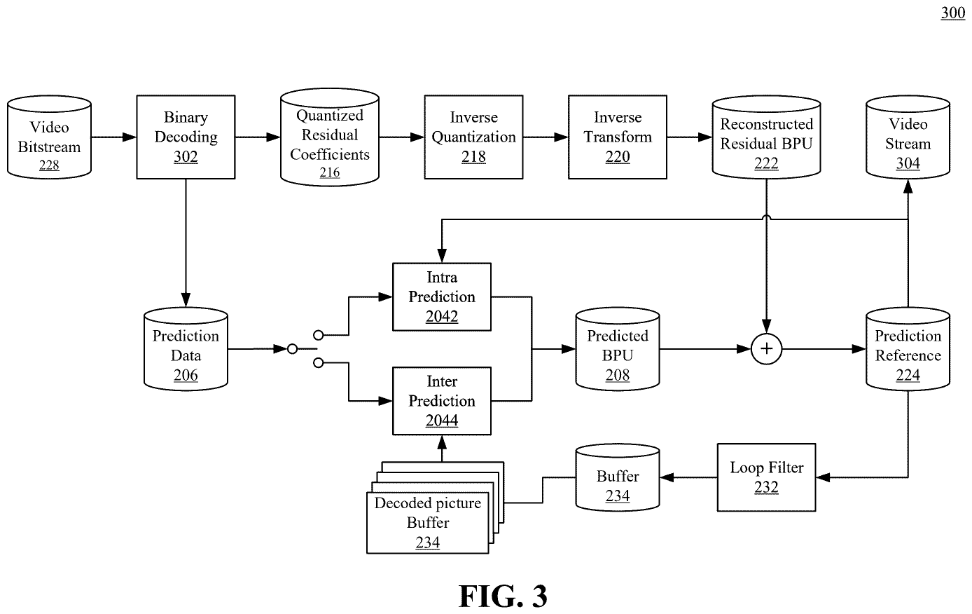

In some cases, a basic processing sub-unit can still be too large to process in some stages of operations in video coding, such as a prediction stage or a transform stage. Accordingly, the encoder can further split the basic processing sub-unit into smaller segments (e.g., referred to as “prediction blocks” or “PBs”), at the level of which a prediction operation can be performed. Similarly, the encoder can further split the basic processing sub-unit into smaller segments (e.g., referred to as “transform blocks” or “TBs”), at the level of which a transform operation can be performed. The division schemes of the same basic processing sub-unit can be different at the prediction stage and the transform stage. For example, the prediction blocks (PBs) and transform blocks (TBs) of the same CU can have different sizes and numbers. Operations in the mode decision stage, the prediction stage, the transform stage will be detailed in later paragraphs with examples provided in FIG. 2 and FIG. 3.

FIG. 2 illustrates a schematic diagram of an example encoder 200 of a video coding system, (e.g., AVS3 or H.26x series), according to some embodiments of the present disclosure. The input video is processed block by block. As discussed above, in some coding standards, a coded tree unit (CTU) is the largest block unit and can be as large as 128×128 luma samples (plus the corresponding chroma samples depending on the chroma format). One CTU may be further partitioned into CUs using quad-tree, binary tree, or ternary tree. Referring to FIG. 2, encoder 200 can receive video sequence 202 generated by a video capturing device (e.g., a camera). The term “receive” used herein can refer to receiving, inputting, acquiring, retrieving, obtaining, reading, accessing, or any action in any manner for inputting data. Encoder 200 can encode video sequence 202 into video bitstream 228. Similar to video sequence 100 in FIG. 1, video sequence 202 can include a set of pictures (referred to as “original pictures”) arranged in a temporal order. Similar to structure 110 in FIG. 1, any original picture of video sequence 202 can be divided by encoder 200 into basic processing units, basic processing sub-units, or regions for processing. In some embodiments, encoder 200 can perform process at the level of basic processing units for original pictures of video sequence 202. For example, encoder 200 can perform process in FIG. 2 in an iterative manner, in which encoder 200 can encode a basic processing unit in one iteration of process. In some embodiments, encoder 200 can perform process in parallel for regions (e.g., slices 114-118 in FIG. 1) of original pictures of video sequence 202.

Components 202, 2042, 2044, 206, 208, 210, 212, 214, 216, 226, and 228 can be referred to as a “forward path.” In FIG. 2, encoder 200 can feed a basic processing unit (referred to as an “original BPU”) of an original picture of video sequence 202 to two prediction stages, intra prediction (also known as an “intra-picture prediction” or “spatial prediction”) stage 2042 and inter prediction (also known as an “inter-picture prediction,” “motion compensation,” “motion compensated prediction” or “temporal prediction”) stage 2044 to perform a prediction operation and generate corresponding prediction data 206 and predicted BPU 208. Particularly, encoder 200 can receive the original BPU and prediction reference 224, which can be generated from the reconstruction path of the previous iteration of process.

The purpose of intra prediction stage 2042 and inter prediction stage 2044 is to reduce information redundancy by extracting prediction data 206 that can be used to reconstruct the original BPU as predicted BPU 208 from prediction data 206 and prediction reference 224. In some embodiments, an intra prediction can use pixels from one or more already coded neighboring BPUs in the same picture to predict the current BPU. That is, prediction reference 224 in the intra prediction can include the neighboring BPUs, so that spatial neighboring samples can be used to predict the current block. The intra prediction can reduce the inherent spatial redundancy of the picture.

In some embodiments, an inter prediction can use regions from one or more already coded pictures (“reference pictures”) to predict the current BPU. That is, prediction reference 224 in the inter prediction can include the coded pictures. The inter prediction can reduce the inherent temporal redundancy of the pictures.

In the forward path, encoder 200 performs the prediction operation at intra prediction stage 2042 and inter prediction stage 2044. For example, at intra prediction stage 2042, encoder 200 can perform the intra prediction. For an original BPU of a picture being encoded, prediction reference 224 can include one or more neighboring BPUs that have been encoded (in the forward path) and reconstructed (in the reconstructed path) in the same picture. Encoder 200 can generate predicted BPU 208 by extrapolating the neighboring BPUs. The extrapolation technique can include, for example, a linear extrapolation or interpolation, a polynomial extrapolation or interpolation, or the like. In some embodiments, encoder 200 can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at inter prediction stage 2042, encoder 200 can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, encoder 200 can add reconstructed residual BPU 222 to predicted BPU 208 to generate a reconstructed BPU. When all reconstructed BPUs of the same picture are generated, encoder 200 can generate a reconstructed picture as a reference picture. Encoder 200 can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When encoder 200 identifies (e.g., by using a pel-recursive algorithm, a block-matching algorithm, or the like) a region similar to the original BPU in the search window, encoder 200 can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. Encoder 200 can record the direction and distance of such a motion as a “motion vector (MV).” In other words, MV is the position difference between the reference block in the reference picture and the current block in the current picture. In inter prediction, the reference block is used as the predictor for the current block, so the reference block is also called predicted block. When multiple reference pictures are used (e.g., as picture 106 in FIG. 1), encoder 200 can search for a matching region and determine its associated MV for each reference picture. In some embodiments, encoder 200 can assign weights to pixel values of the matching regions of respective matching reference pictures.

The motion estimation can be used to identify various types of motions, such as, for example, translations, rotations, zooming, or the like. For inter prediction, prediction data 206 can include, for example, reference index, locations (e.g., coordinates) of the matching region, MVs associated with the matching region, number of reference pictures, weights associated with the reference pictures, or other motion information.

For generating predicted BPU 208, encoder 200 can perform an operation of “motion compensation.” The motion compensation can be used to reconstruct predicted BPU 208 based on prediction data 206 (e.g., the MV) and prediction reference 224. For example, encoder 200 can move the matching region of the reference picture according to the MV, in which encoder 200 can predict the original BPU of the current picture. When multiple reference pictures are used (e.g., as picture 106 in FIG. 1), encoder 200 can move the matching regions of the reference pictures according to the respective MVs and average pixel values of the matching regions. In some embodiments, if encoder 200 has assigned weights to pixel values of the matching regions of respective matching reference pictures, encoder 200 can add a weighted sum of the pixel values of the moved matching regions.

In some embodiments, the inter prediction can utilize uni-prediction or bi-prediction and be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (i.e., picture 102) precedes picture 104. In uni-prediction, only one MV pointing to one reference picture is used to generate the prediction signal for the current block.

On the other hand, bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at opposite temporal directions with respect to picture 104. In bi-prediction, two MVs, each pointing to its own reference picture, are used to generate the prediction signal of the current block. After video bitstream 228 is generated, MVs and reference indices can be sent in video bitstream 228 to a decoder, to identify where the prediction signal(s) of the current block come from.

For inter-predicted CUs, motion parameters may include MVs, reference picture indices and reference picture list usage index, or other additional information needed for coding features to be used. Motion parameters can be signaled in an explicit or implicit manner. In some embodiments, under some specific inter coding modes, such as a skip mode or a direct mode, motion parameters (e.g., MV difference and reference picture index) are not coded and signaled in video bitstream 228. Instead, the motion parameters can be derived at the decoder side with the same rule as defined in encoder 200. Details of the skip mode and the direct mode will be discussed in the paragraphs below.

After intra prediction stage 2042 and inter prediction stage 2044, at mode decision stage 230, encoder 200 can select a prediction mode (e.g., one of the intra prediction or the inter prediction) for the current iteration of process. For example, encoder 200 can perform a rate-distortion optimization method, in which encoder 200 can select a prediction mode to minimize a value of a cost function depending on a bit rate of a candidate prediction mode and distortion of the reconstructed reference picture under the candidate prediction mode. Depending on the selected prediction mode, encoder 200 can generate the corresponding predicted BPU 208 (e.g., a prediction block) and prediction data 206.

In some embodiments, predicted BPU 208 can be identical to the original BPU. However, due to non-ideal prediction and reconstruction operations, predicted BPU 208 is generally slightly different from the original BPU. For recording such differences, after generating predicted BPU 208, encoder 200 can subtract it from the original BPU to generate residual BPU 210, which is also called a prediction residual.

For example, encoder 200 can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

After residual BPU 210 is generated, encoder 200 can feed residual BPU 210 to transform stage 212 and quantization stage 214 to generate quantized residual coefficients 216. To further compress residual BPU 210, at transform stage 212, encoder 200 can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, encoder 200 can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, encoder 200 and a corresponding decoder (e.g., decoder 300 in FIG. 3) can use the same transform algorithm (thus the same base patterns). Thus, encoder 200 can record only the transform coefficients, from which decoder 300 can reconstruct residual BPU 210 without receiving the base patterns from encoder 200. Compared with residual BPU 210, the transform coefficients can have fewer bits, but they can be used to reconstruct residual BPU 210 without significant quality deterioration. Thus, residual BPU 210 is further compressed.

Encoder 200 can further compress the transform coefficients at quantization stage 214. In the transform process, different base patterns can represent different variation frequencies (e.g., brightness variation frequencies). Because human eyes are generally better at recognizing low-frequency variation, encoder 200 can disregard information of high-frequency variation without causing significant quality deterioration in decoding. For example, at quantization stage 214, encoder 200 can generate quantized residual coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. Encoder 200 can disregard the zero-value quantized residual coefficients 216, by which the transform coefficients are further compressed. The quantization process is also invertible, in which quantized residual coefficients 216 can be reconstructed to the transform coefficients in an inverse operation of the quantization (referred to as “inverse quantization”).

Because encoder 200 disregards the remainders of such divisions in the rounding operation, quantization stage 214 can be lossy. Typically, quantization stage 214 can contribute the most information loss in the encoding process. The larger the information loss is, the fewer bits the quantized residual coefficients 216 can need. For obtaining different levels of information loss, encoder 200 can use different values of the quantization parameter or any other parameter of the quantization process.

Encoder 200 can feed prediction data 206 and quantized residual coefficients 216 to binary coding stage 226 to generate video bitstream 228 to complete the forward path. At binary coding stage 226, encoder 200 can encode prediction data 206 and quantized residual coefficients 216 using a binary coding technique, such as, for example, entropy coding, variable length coding, arithmetic coding, Huffman coding, context-adaptive binary arithmetic coding (CABAC), or any other lossless or lossy compression algorithm.

For example, the encoding process of CABAC in binary coding stage 226 may include a binarization step, a context modeling step, and a binary arithmetic coding step. If the syntax element is not binary, encoder 200 first maps the syntax element to a binary sequence. Encoder 200 may select a context coding mode or a bypass coding mode for coding. In some embodiments, for context coding mode, the probability model of the bin to be encoded is selected by the “context”, which refers to the previous encoded syntax elements. Then the bin and the selected context model is passed to an arithmetic coding engine, which encodes the bin and updates the corresponding probability distribution of the context model. In some embodiments, for the bypass coding mode, without selecting the probability model by the “context,” bins are encoded with a fixed probability (e.g., a probability equal to 0.5). In some embodiments, the bypass coding mode is selected for specific bins in order to speed up the entropy coding process with negligible loss of coding efficiency.

In some embodiments, in addition to prediction data 206 and quantized residual coefficients 216, encoder 200 can encode other information at binary coding stage 226, such as, for example, the prediction mode selected at the prediction stage (e.g., intra prediction stage 2042 or inter prediction stage 2044), parameters of the prediction operation (e.g., intra prediction mode, motion information, etc.), a transform type at transform stage 212, parameters of the quantization process (e.g., quantization parameters), an encoder control parameter (e.g., a bitrate control parameter), or the like. That is, coding information can be sent to binary coding stage 226 to further reduce the bit rate before being packed into video bitstream 228. Encoder 200 can use the output data of binary coding stage 226 to generate video bitstream 228. In some embodiments, video bitstream 228 can be further packetized for network transmission.

Components 218, 220, 222, 224, 232, and 234 can be referred to as a “reconstruction path.” The reconstruction path can be used to ensure that both encoder 200 and its corresponding decoder (e.g., decoder 300 in FIG. 3) use the same reference data for prediction.

During the process, after quantization stage 214, encoder 200 can feed quantized residual coefficients 216 to inverse quantization stage 218 and inverse transform stage 220 to generate reconstructed residual BPU 222. At inverse quantization stage 218, encoder 200 can perform inverse quantization on quantized residual coefficients 216 to generate reconstructed transform coefficients. At inverse transform stage 220, encoder 200 can generate reconstructed residual BPU 222 based on the reconstructed transform coefficients. Encoder 200 can add reconstructed residual BPU 222 to predicted BPU 208 to generate prediction reference 224 to be used in prediction stages 2042, 2044 for the next iteration of process.

In the reconstruction path, if intra prediction mode has been selected in the forward path, after generating prediction reference 224 (e.g., the current BPU that has been encoded and reconstructed in the current picture), encoder 200 can directly feed prediction reference 224 to intra prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), encoder 200 can feed prediction reference 224 to loop filter stage 232, at which encoder 200 can apply a loop filter to prediction reference 224 to reduce or eliminate distortion (e.g., blocking artifacts) introduced by the inter prediction. Encoder 200 can apply various loop filter techniques at loop filter stage 232, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in buffer 234 (or “decoded picture buffer”) for later use (e.g., to be used as an inter-prediction reference picture for a future picture of video sequence 202). Encoder 200 can store one or more reference pictures in buffer 234 to be used at inter prediction stage 2044. In some embodiments, encoder 200 can encode parameters of the loop filter (e.g., a loop filter strength) at binary coding stage 226, along with quantized residual coefficients 216, prediction data 206, and other information.

Encoder 200 can perform the process discussed above iteratively to encode each original BPU of the original picture (in the forward path) and generate prediction reference 224 for encoding the next original BPU of the original picture (in the reconstruction path). After encoding all original BPUs of the original picture, encoder 200 can proceed to encode the next picture in video sequence 202.

It should be noted that other variations of the encoding process can be used to encode video sequence 202. In some embodiments, stages of process can be performed by encoder 200 in different orders. In some embodiments, one or more stages of the encoding process can be combined into a single stage. In some embodiments, a single stage of the encoding process can be divided into multiple stages. For example, transform stage 212 and quantization stage 214 can be combined into a single stage. In some embodiments, the encoding process can include additional stages that are not shown in FIG. 2. In some embodiments, the encoding process can omit one or more stages in FIG. 2.

For example, in some embodiments, encoder 200 can be operated in a transform skipping mode. In the transform skipping mode, transform stage 212 is bypassed and a transform skip flag is signaled for the TB. This may improve compression for some types of video content such as computer-generated images or graphics mixed with camera-view content (e.g., scrolling text). In addition, encoder 200 can also be operated in a lossless mode. In the lossless mode, transform stage 212, quantization stage 214, and other processing that affects the decoded picture (e.g., SAO and deblocking filters) are bypassed. The residual signal from the intra prediction stage 2042 or inter prediction stage 2044 is fed into binary coding stage 226, using the same neighborhood contexts applied to the quantized transform coefficients. This allows mathematically lossless reconstruction. Therefore, both transform and transform skip residual coefficients are coded within non-overlapped CGs. That is, each CG may include one or more transform residual coefficients, or one or more transform skip residual coefficients.

FIG. 3 illustrates a block diagram of an example decoder 300 of a video coding system (e.g., AVS3 or H.26x series), according to some embodiments of the present disclosure. Decoder 300 can perform a decompression process corresponding to the compression process in FIG. 2. The corresponding stages in the compression process and decompression process are labeled with the same numbers in FIG. 2 and FIG. 3.

In some embodiments, the decompression process can be similar to the reconstruction path in FIG. 2. Decoder 300 can decode video bitstream 228 into video stream 304 accordingly. Video stream 304 can be very similar to video sequence 202 in FIG. 2. However, due to the information loss in the compression and decompression process (e.g., quantization stage 214 in FIG. 2), video stream 304 may be not identical to video sequence 202. Similar to encoder 200 in FIG. 2, decoder 300 can perform the decoding process at the level of basic processing units (BPUs) for each picture encoded in video bitstream 228. For example, decoder 300 can perform the process in an iterative manner, in which decoder 300 can decode a basic processing unit in one iteration. In some embodiments, decoder 300 can perform the decoding process in parallel for regions (e.g., slices 114-118) of each picture encoded in video bitstream 228.

In FIG. 3, decoder 300 can feed a portion of video bitstream 228 associated with a basic processing unit (referred to as an “encoded BPU”) of an encoded picture to binary decoding stage 302. At binary decoding stage 302, decoder 300 can unpack and decode video bitstream into prediction data 206 and quantized residual coefficients 216. Decoder 300 can use prediction data 206 and quantized residual coefficients to reconstruct video stream 304 corresponding to video bitstream 228. Decoder 300 can perform an inverse operation of the binary coding technique used by encoder 200 (e.g., entropy coding, variable length coding, arithmetic coding, Huffman coding, context-adaptive binary arithmetic coding, or any other lossless compression algorithm) at binary decoding stage 302. In some embodiments, in addition to prediction data 206 and quantized residual coefficients 216, decoder 300 can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, decoder 300 can depacketize video bitstream 228 before feeding it to binary decoding stage 302. Decoder 300 can feed quantized residual coefficients 216 to inverse quantization stage 218 and inverse transform stage 220 to generate reconstructed residual BPU 222. Decoder 300 can feed prediction data 206 to intra prediction stage 2042 and inter prediction stage 2044 to generate predicted BPU 208. Particularly, for an encoded basic processing unit (referred to as a “current BPU”) of an encoded picture (referred to as a “current picture”) that is being decoded, prediction data 206 decoded from binary decoding stage 302 by decoder 300 can include various types of data, depending on what prediction mode was used to encode the current BPU by encoder 200. For example, if intra prediction was used by encoder 200 to encode the current BPU, prediction data 206 can include coding information such as a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by encoder 200 to encode the current BPU, prediction data 206 can include coding information such as a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more MVs respectively associated with the matching regions, or the like.

Accordingly, the prediction mode indicator can be used to select whether inter or intra prediction module will be invoked. Then, parameters of the corresponding prediction operation can be sent to the corresponding prediction module to generate the prediction signal(s). Particularly, based on the prediction mode indicator, decoder 300 can decide whether to perform an intra prediction at intra prediction stage 2042 or an inter prediction at inter prediction stage 2044. The details of performing such intra prediction or inter prediction are described in FIG. 2 and will not be repeated hereinafter. After performing such intra prediction or inter prediction, decoder 300 can generate predicted BPU 208.

After predicted BPU 208 is generated, decoder 300 can add reconstructed residual BPU 222 to predicted BPU 208 to generate prediction reference 224. In some embodiments, prediction reference 224 can be stored in a buffer (e.g., a decoded picture buffer in a computer memory). Decoder 300 can feed prediction reference 224 to intra prediction stage 2042 and inter prediction stage 2044 for performing a prediction operation in the next iteration.

For example, if the current BPU is decoded using the intra prediction at intra prediction stage 2042, after generating prediction reference 224 (e.g., the decoded current BPU), decoder 300 can directly feed prediction reference 224 to intra prediction stage 2042 for later usage (e.g., for extrapolation of a next BPU of the current picture). If the current BPU is decoded using the inter prediction at inter prediction stage 2044, after generating prediction reference 224 (e.g., a reference picture in which all BPUs have been decoded), decoder 300 can feed prediction reference 224 to loop filter stage 232 to reduce or eliminate distortion (e.g., blocking artifacts). In addition, prediction data 206 can further include parameters of a loop filter (e.g., a loop filter strength). Accordingly, decoder 300 can apply the loop filter to prediction reference 224, in a way as described in FIG. 2. For example, loop filters such as deblocking, SAO or ALF may be applied to form the loop-filtered reference picture, which are stored in buffer 234 (e.g., a decoded picture buffer (DPB) in a computer memory) for later use (e.g., to be used at inter prediction stage 2044 for prediction of a future encoded picture of video bitstream 228). In some embodiments, reconstructed pictures from buffer 234 can also be sent to a display, such as a TV, a PC, a smartphone, or a tablet to be viewed by the end-users. Decoder 300 can perform the decoding process iteratively to decode each encoded BPU of the encoded picture and generate prediction reference 224 for encoding the next encoded BPU of the encoded picture. After decoding all encoded BPUs of the encoded picture, decoder 300 can output the picture to video stream 304 for display and proceed to decode the next encoded picture in video bitstream 228.

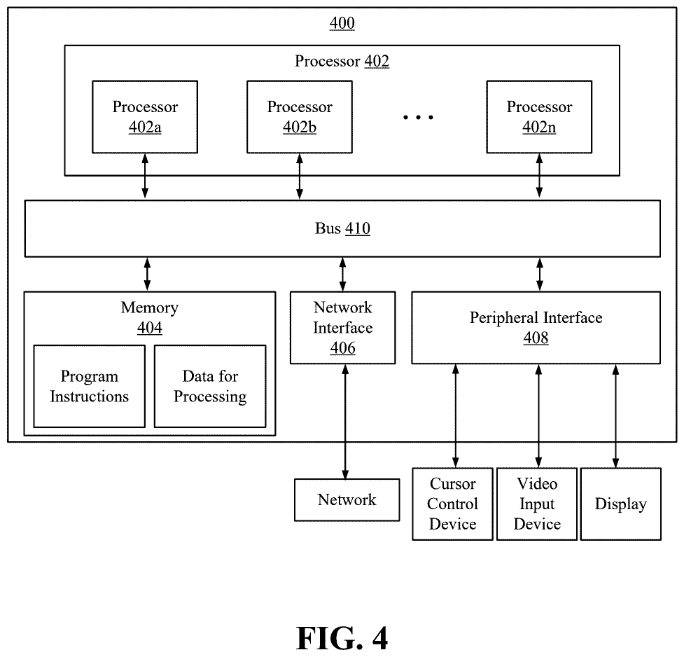

FIG. 4 is a block diagram of an example apparatus 400 for encoding or decoding a video, according to some embodiments of the present disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in FIG. 2 and FIG. 3) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in the present disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process of encoder 200 or decoder 300) can be implemented as any combination of any software or hardware modules in apparatus 400. For example, some or all stages of process encoder 200 or decoder 300 can be implemented as one or more software modules of apparatus 400, such as program instructions that can be loaded into memory 404. For another example, some or all stages of process encoder 200 or decoder 300 can be implemented as one or more hardware modules of apparatus 400, such as a specialized data processing circuit (e.g., an FPGA, an ASIC, an NPU, or the like).

In the inter prediction stage 2044 in FIG. 2 and FIG. 3, reference index is used to indicate which previously coded picture the reference block is from. The motion vector (MV), the position difference between the reference block in the reference picture and the current block in the current picture, is used to indicate the position of the reference block in the reference picture. For bi-prediction (e.g., picture 106 in FIG. 1), two reference blocks, one from a reference picture in reference picture List 0 (e.g., picture 104) and the other from a reference picture in reference picture List 1 (e.g., picture 108) are used to generate the combined predicted block. Accordingly, two reference indices, (e.g., List 0 reference index and List 1 reference index), and two motion vectors (e.g., List 0 motion vector and List 1 motion vector) are required for bi-prediction. The motion vector is determined by the encoder and signaled to the decoder. In some embodiments, to save the signaling cost, a motion vector difference (MVD) is signaled in the bitstream instead. For a decoder, a motion vector predictor (MVP) can be derived based on the spatial and temporal neighboring block motion information, and the MV can be obtained by adding the MVD parsed from the bitstream to the MVP.

As discussed above, the video encoding or decoding process can be achieved using different modes. In some normal inter coding modes, encoder 200 can signal MV(s), corresponding reference picture index for each reference picture list and reference picture list usage flag, or other information explicitly per each CU. On the other hand, when a CU is coded with a skip mode or a direct mode, the motion information, including reference index and motion vector, is not signaled in video bitstream 228 to decoder 300. Instead, the motion information can be derived at decoder 300 using the same rule as encoder 200 does. The skip mode and the direct mode share the same motion information derivation rule and thus have the same motion information. A difference between these two modes is that in the skip mode, the signaling of the prediction residuals is skipped by setting residuals to be zero. In the direct mode, prediction residuals are still signaled in the bitstream.

For example, when a CU is coded with a skip mode, the CU is associated with one PU and has no significant residual coefficients, no coded MV difference or reference picture index. In the skip mode, the signaling of the residual data can be skipped by setting residuals to be zero. In the direct mode, the residual data is transmitted while the motion information and partitions are derived.

On the other hand, in inter modes, encoder 200 can choose any allowed values for motion vector and reference index as the motion vector difference and reference index are signaled to decoder 300. Compared with inter modes signaling the motion information, the bits dedicated on the motion information can thus be saved in the skip mode or the direct mode. However, encoder 200 and decoder 300 need to follow the same rule to derive the motion vector and reference index to perform inter prediction 2044. In some embodiments, the derivation of the motion information can be based on the spatial or temporal neighboring block. Accordingly, the skip mode and the direct mode are suitable for the case where the motion information of the current block is close to that of the spatial or temporal neighboring blocks of the current block.

For example, the skip mode or the direct mode may enable the motion information (e.g., reference index, MVs, etc.) to be inherited from a spatial or temporal (co-located) neighbor. A candidate list of motion candidates can be generated from these neighbors. In some embodiments, to derive the motion information used for inter prediction 2044 in skip mode or direct mode, encoder 200 may first derive the candidate list of motion candidates and select one of the motion candidates to perform inter prediction 2044. When signaling video bitstream 228, encoder 200 may signal an index of the selected candidate. At the decoder side, decoder 300 can obtain the index parsed from video bitstream 228, derive the same candidate list, and use the same motion candidate (including motion vector and reference picture index) to perform inter prediction 2044.

Inter prediction, which exploits the correlation between pictures at different time instance by using block-based motion compensation prediction (MCP), is always one of the main focuses of video coding technology development. In MCP, for a current coding block, one or more reference blocks are located in the reference pictures by motion vectors (MVs) and reference picture indices. The reference picture index is the index of the reference picture used for the current coding block to the list of reference pictures. So the reference picture index is used to determine the reference picture used. There are two reference picture lists: reference picture list 0 and reference picture list 1. Thus, two indices, one index for one reference picture, are needed if bi-prediction is used for the current coding block. The motion vector (MV) which is the position displacement between the current coding block in the current picture and the reference block in the reference picture is used to locate the reference block in the reference picture indicated by the reference picture index. After the reference blocks are located in the reference picture, the predictor block is derived from the reference block. In bi-prediction case, the predictor block is derived by weighted averaging two reference blocks and in uni-prediction case, the predictor block is equal to the reference block. Then, the residue block is generated by subtracting the predictor block from the current block. After transform and quantization, the quantized residual coefficients are entropy coded and signaled in the bitstream together with motion information such as motion vectors and reference indices.

There are two modes for inter prediction: advanced motion vector predictor (AMVP) mode and merge mode. In AMVP mode, the encoder searches the reference blocks in the reference pictures by using original samples of the current coding block, which is called motion estimation. After reference block is determined, the reference index of the reference picture and the motion vectors referring to the reference block is signaled in the bitstream. To save the signaling cost, the MV is also predicted and only the difference between the MV and motion vector predictor (MVP) is signaled.

To further reduce the signaling cost, a merge mode was proposed. In merge mode, the MV and reference picture are not explicitly signaled. Instead, a merge candidate index is signaled. First, in the both encoder and decoder side, a merge list of motion candidate is constructed with each motion candidate derived based on the previously coded blocks. Then, the encoder chooses the best candidate from the candidate list and signal the index of the candidate chosen. In the decoder side, the candidate index is decoded from the bitstream and then the motion candidate is determined based on the decoded index. Then the motion of that candidate is applied to the current block to get the reference blocks in the reference picture. For merge mode, the encoder does not need to perform motion estimation, but only needs to choose the candidate from the merge candidate list.

There are different types of candidates in the merge candidate list which includes: Spatial MVP from spatial neighbour CUs, Temporal MVP from collocated CUs, non-adjacent spatial candidates, History-based MVP from a FIFO table, pairwise average MVP, and zero MVs.

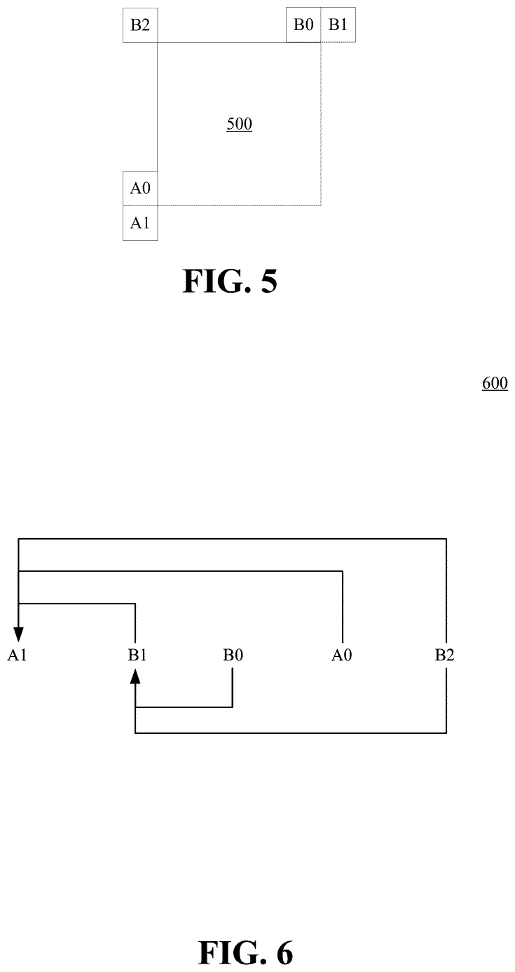

The derivation of spatial merge candidates in VVC is the same to that in HEVC except the positions of first two merge candidates are swapped. FIG. 5 is a schematic diagram illustrating example positions of spatial merge candidate, according to some embodiments of the present disclosure. A maximum of four merge candidates for a block 500 are selected among candidates located in the positions A0, A1, and B0-B2 depicted in FIG. 5. The order of derivation is positions B0, A0, B1, A1, and B2. The position B2 is considered only when one or more than one CUs of position B0, A0, B1, A1 are not available (e.g., because it belongs to another slice or tile) or is intra coded. After the candidate at position A1 is added, the addition of the remaining candidates is subject to a redundancy check which ensures that candidates with same motion information are excluded from the list so that coding efficiency is improved.

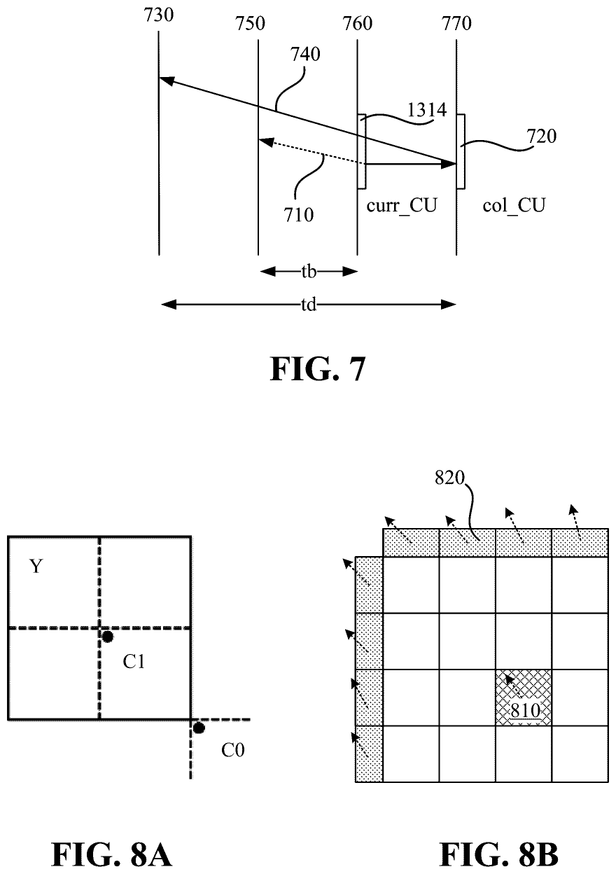

FIG. 6 is a schematic diagram illustrating example candidate pairs considered for redundancy check of spatial merge candidates, according to some embodiments of the present disclosure. In some embodiments, to reduce computational complexity, not all possible candidate pairs are considered in the mentioned redundancy check. Instead, only the pairs linked with an arrow in FIG. 6 are considered and a candidate is only added to the list if the corresponding candidate used for redundancy check does not have the same motion information.

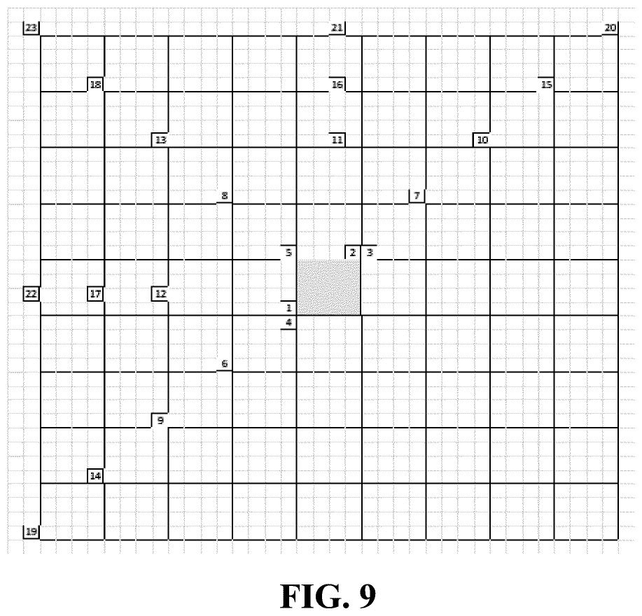

FIG. 7 is a schematic diagram illustrating example motion vector scaling for temporal merge candidate, according to some embodiments of the present disclosure. In the derivation of temporal merge candidate, a scaled motion vector 710 is derived based on co-located CU 720 belonging to the collocated reference picture 730. The reference picture list and the reference index to be used for derivation of the co-located CU 720 is explicitly signalled in the slice header. The scaled motion vector 710 for temporal merge candidate is obtained as illustrated by the dotted line in FIG. 7, which is scaled from the motion vector 740 of the co-located CU 720 using the POC distances tb and td, where the POC distance tb is defined to be the POC difference between the reference picture 750 of the current picture 760 and the current picture 760 and the POC distance td is defined to be the POC difference between the reference picture 730 of the co-located picture 770 and the co-located picture 770. The reference picture index of temporal merge candidate is set equal to zero.

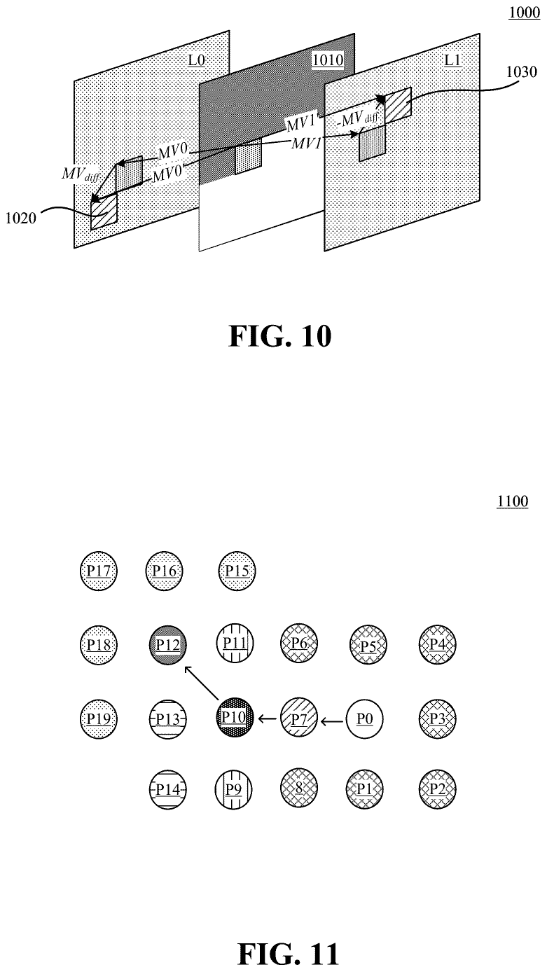

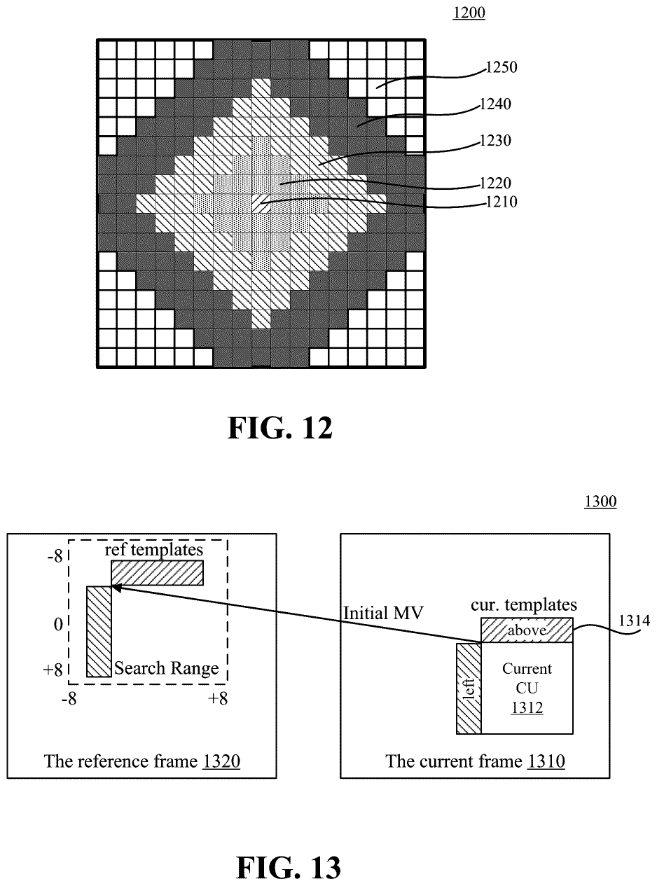

FIG. 8A is a schematic diagram illustrating example candidate positions for temporal merge candidate, according to some embodiments of the present disclosure. In some embodiments, the position for the temporal candidate can be selected between candidates C0 and C1, as depicted in FIG. 8A. If CU at position C0 is not available, is intra coded, or is outside of the current row of CTUs, position C1 is used. Otherwise, position C0 is used in the derivation of the temporal merge candidate.

In ECM, to further improve the coding efficiency of temporal motion vector prediction (TMVP), two aspects are modified. Firstly, two collocated pictures are utilized which are the two reference frames with the least POC distance relative to the to-be-coded frame. Secondly, the motion shift to locate TMVP is adaptively determined from multiple locations according to template costs. More specifically, two motion shift candidate lists are constructed respectively for the two collocated frames. The motion shifts with the minimum template matching cost are used to derive subblock-based temporal motion vector prediction (SbTMVP) or TMVP candidates. At most 4 SbTMVP candidates are included in the sub-block-based merge list. The SbTMVP candidate with the least template matching cost derived from the first collocated frame is placed in the first entry without reordering, while other SbTMVP candidates are sorted together with affine candidates. In addition, the prediction direction of each subblock template is determined based on the center subblock.

FIG. 8B is a schematic diagram illustrating example subblock templates generation of subblock-based temporal motion vector prediction (SbTMVP), according to some embodiments of the present disclosure. In some embodiments, as illustrated in FIG. 8B, if the center subblock 810 is uni-predicted, then all the subblock templates 820 are uni-predicted, and vice versa. If the motion vector of corresponding adjacent subblock at the determined reference list is not available for a subblock template, zero MV is used for that subblock template.

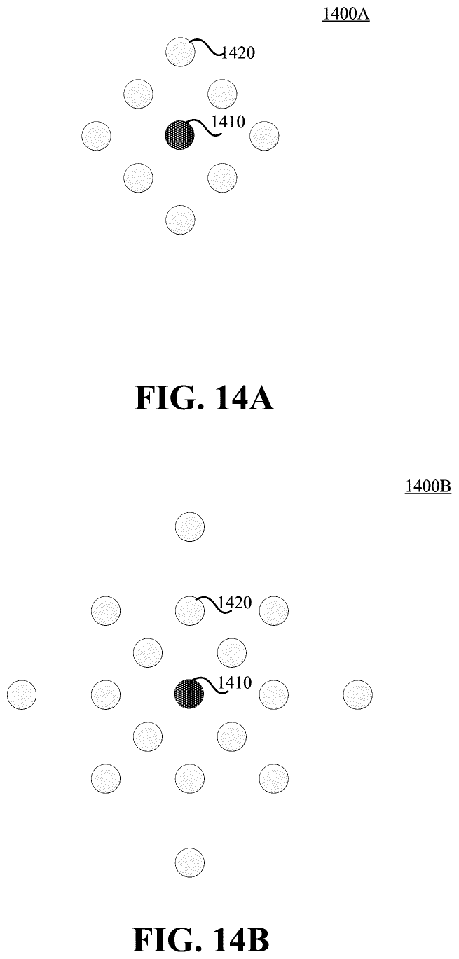

The non-adjacent spatial merge candidates as in JVET-L0399 are inserted after the temporal motion vector prediction (TMVP) in the regular merge candidate list. FIG. 9 is a schematic diagram illustrating example spatial neighboring blocks used to derive the spatial merge candidates, according to some embodiments of the present disclosure. The pattern of spatial merge candidates is shown in FIG. 9. The distances between non-adjacent spatial candidates and current coding block are based on the width and height of current coding block. The line buffer restriction is not applied.

In some embodiments, the history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced. First, the last two entries in the table are redundancy checked to A1 and B1 spatial candidates, respectively. Second, once the total number of available merge candidates reaches the maximally allowed merge candidates minus 1, the merge candidate list construction process from HMVP is terminated.

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

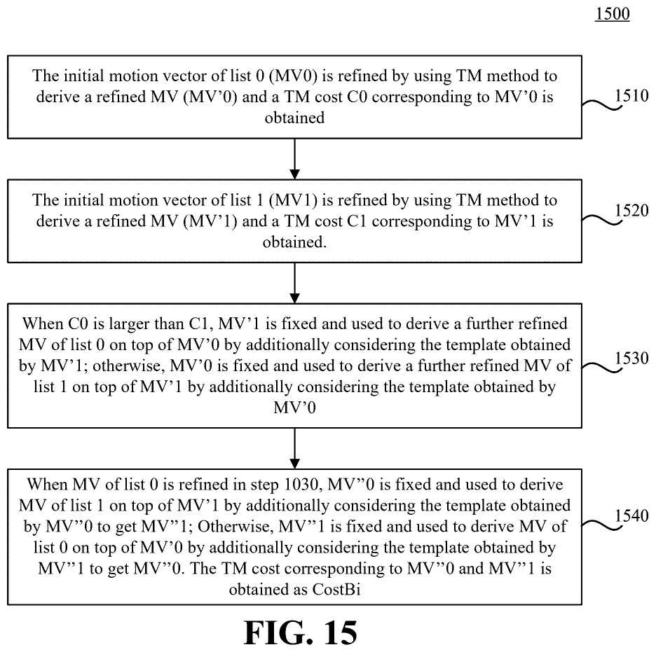

Next, decoder-side motion vector refinement (DMVR) used in the disclosed embodiments is described. FIG. 10 illustrates an example decoding side motion vector refinement (DMVR) process 1000, according to some embodiments of the present disclosure.

As illustrated in FIG. 10, in some embodiments, in order to refine the motion derived in the merge mode, a bilateral-matching (BM) based decoder side motion vector refinement can be adopted in bi-prediction operation to increase the accuracy of the MVs of the merge mode. In DMVR, for a current picture 1010, a refined MV (e.g., MV₀′ and MV₁′) is searched around the initial MVs (e.g., MV₀ and MV₁) in the reference picture list L0 and reference picture list L1. The BM method calculates the distortion between the two candidate blocks in the reference picture list L0 and list L1. As illustrated in FIG. 10, the sum of absolute difference (SAD) between the blocks 1020 and 1030 based on each MV candidate around the initial MV is calculated. The MV candidate with the lowest SAD becomes the refined MV and used to generate the bi-predicted signal.

In some embodiments, the application of DMVR is restricted and is only applied for the CUs which are coded with following modes and features: (1) CU level merge mode with bi-prediction MV; (2) one reference picture is in the past and another reference picture is in the future with respect to the current picture; (3) the distances (i.e., POC difference) from two reference pictures to the current picture are same; (4) both reference pictures are short-term reference pictures; (5) CU has more than 64 luma samples; (6) both CU height and CU width are larger than or equal to 8 luma samples; (7) BCW weight index indicates equal weight; (8) WP is not enabled for the current block; (9) CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding. The additional features of DMVR will be described in the following paragraphs.

In DMVR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset \qquad ( 1 )$$

$$MV {1}^{′} = MV 1 - MV\_offset \qquad ( 2 )$$

where MV_offset represents the refinement offset between the initial MV and the refined MV in one of the reference pictures. The refinement search range is two integer luma samples from the initial MV. The search includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form:

$$E ( x , y ) = {A ( x - {x}_{min} )}^{2} + {B ( y - {y}_{min} )}^{2} + C \qquad ( 3 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 4 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 5 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ) yₘᵢₙ) are added to the integer distance refinement MV to get the sub-pixel accurate refinement delta MV.

Next, bilinear-interpolation and sample padding is described. In VVC, the resolution of the MVs is 1/16 luma samples. The samples at the fractional position are interpolated using an 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DMVR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

When the width and/or height of a CU are larger than 16 luma samples, it will be further split into subblocks with width and/or height equal to 16 luma samples. The maximum unit size for DMVR searching process is limited to 16×16.

Next, multi-pass decoder-side motion vector refinement (MP-DMVR) is described. In ECM, to further improve the coding efficiency, a multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8 or other values.

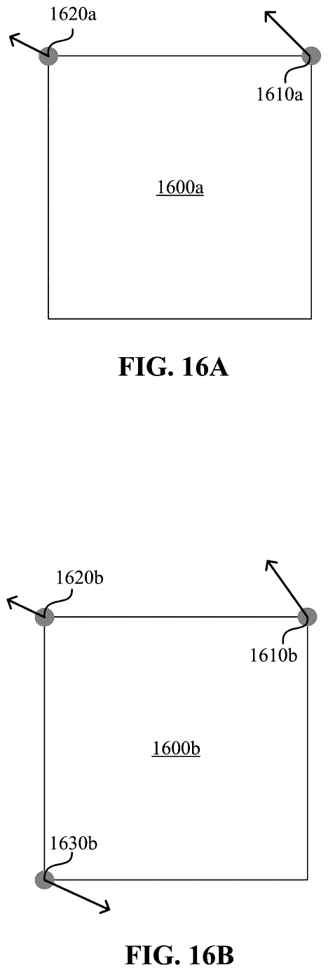

FIG. 11 illustrates an example 3×3 square search pattern 1100 for the first pass in the MP-DMVR, according to some embodiments of the present disclosure. For example, as in FIG. 11, point P0 is the position to which the initial MV refers. So, the points P1-P8 surrounding the initial position are searched first and the cost of each position is calculated. If point P7 is with minimum cost, then point P7 is set as search center and points P9-P11 are searched. If cost of point P10 is smaller than the point P7, the search center goes to point P10 and points P12-P14 are searched. If point P12 has the minimum cost among points P6-14, point P12 is set as new search center. If points P10, P11, P13, and P15-P19 surrounding the point P12 are all larger than point P12, then point 12 is the best position and the search process stops.

The bilateral matching cost is calculated as: bilCost=mvDistanceCost+sadCost, wherein sadCost is the SAD between 10 predictor and 11 predictor on each search point and mvDistanceCost is based on intDeltaMV (i.e., the distance between the search point and the initial position). When the block size cbW*cbH is greater than 64, MRSAD cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV 0\_ pass 1 = MV 0 + deltaMV$$

$$MV 1\_ pass 1 = MV 1 + deltaMV$$

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2 (sbIdx2) and MV1_pass2 (sbIdx2)) are derived based on the minimum bilateral matching cost between the two reference subblocks in L0 and L1.

For each subblock, BM performs full search to derive integer sample precision intDeltaMV (sbIdx2). The full search has a search range [−sHor, sHor] in horizontal direction and [−sVer, sVer] in vertical direction, wherein, the values of sHor and sVer are determined by the block dimension, and the maximum value of sHor and sVer is 8 or other values.

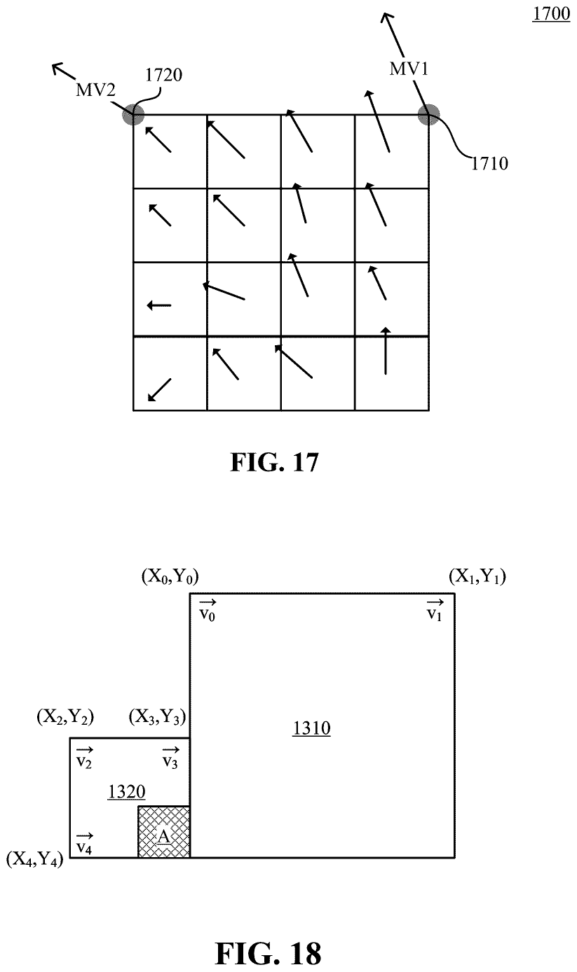

FIG. 12 illustrates an example of diamond regions 1210-1250 in the search area 1200 for the second pass in the MP-DMVR, according to some embodiments of the present disclosure. The bilateral matching cost is calculated by applying a cost factor to the sum of absolute transformed differences (SATD) cost between two reference subblocks, as: bilCost=satdCost*costFactor. The search area (2*sHor+1)*(2*sVer+1) is divided up to 5 diamond shape search regions 1210-1250 shown in FIG. 12. Each search region 1210-1250 is assigned a costFactor, which is determined by the distance intDeltaMV (sbIdx2) between each search point and the starting MV, and each diamond region 1210-1250 is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement can be further applied to derive the final deltaMV (sbIdx2). The refined MVs at second pass is then derived as:

$$MV0\_pass2 ( sbIdx 2 ) = MV0\_pass1 + deltaMV ( sbIdx 2 )$$

$$MV1\_pass2 ( sbIdx 2 ) = MV1\_pass1 - deltaMV ( sbIdx 2 )$$

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3 (sbIdx3) and MV1_pass3 (sbIdx3)) at third pass are derived as:

$$MV0\_pass3 ( sbIdx 3 ) = MV0\_pass2 ( sbIdx 2 ) + bioMv$$

$$MV1\_pass3 ( sbIdx 3 ) = MV0\_pass2 ( sbIdx 2 ) - bioMv$$

In ECM, adaptive decoder side motion vector refinement method is an extension of multi-pass DMVR which consists of the two new merge modes to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1st pass (i.e., PU level) DMVR. Thus, a new merge candidate list is constructed for adaptive decoder-side motion vector refinement. And the new merge mode for the new merge candidate list is called BM merge in ECM.

The merge candidates for BM merge mode are derived from spatial neighboring coded blocks, TMVPs, non-adjacent blocks, history based motion vector predictors (HMVPs), pair-wise candidate, similar as in the regular merge mode. The difference is that only those merge candidates meeting DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

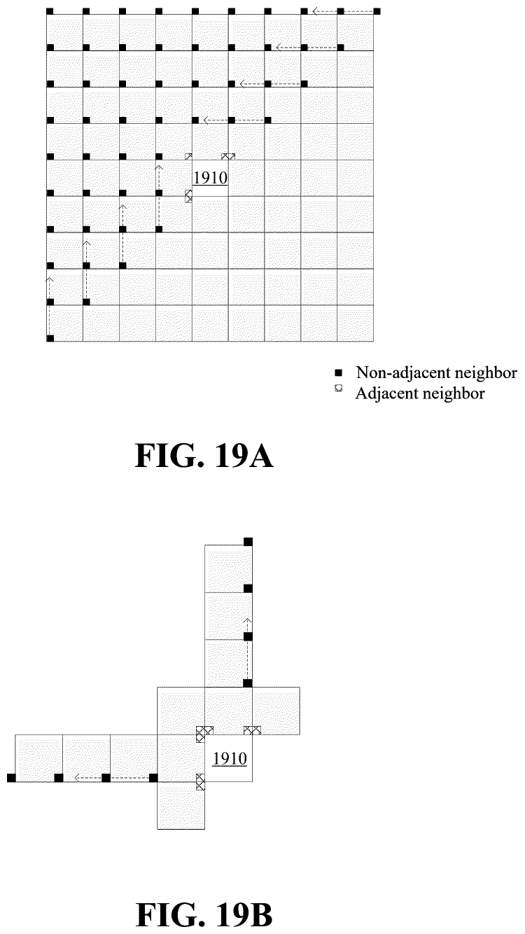

FIG. 13 illustrates an example template matching process 1300 performed on a search area around initial MV, according to some embodiments of the present disclosure. Template matching (TM) is a decoder-side MV derivation method to refine the motion information of the current CU 1312 in the current frame 1310 by finding the closest match between a template (e.g., top and/or left neighboring blocks 1314 of the current CU 1312) in the current frame 1310 and a block (e.g., same size to the template) in a reference frame 1320. As illustrated in FIG. 13, a better MV is searched around the initial motion of the current CU 1312 within a [−8, +8]-pel search range. To efficiently combined with adaptive motion vector resolution (AMVR) and decoder side motion vector refinement (DMVR), the search step size of TM can be determined based on AMVR mode and TM can be cascaded with DMVR process in merge modes.

In AMVP mode, an MVP candidate is determined based on template matching error to select the one which reaches the minimum cost. The cost is calculated as the difference between the current block template and the reference block template. And then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

TABLE 1
Search patterns of AMVR and merge mode with AMVR

| | AMVR mode | | | | Merge mode | |
|---|---|---|---|---|---|---|
| Search | 4- | Full- | Half- | Quarter- | AltIF = | AltIF = |
| pattern | pel | pel | pel | pel | 0 | 1 |
| 4-pel | v | | | | | |
| diamond | | | | | | |
| 4-pel cross | v | | | | | |
| Full-pel | | v | v | v | v | v |
| diamond | | | | | | |
| Full-pel | | v | v | v | v | v |
| cross | | | | | | |
| Half-pel | | | v | v | v | v |
| cross | | | | | | |
| Quarter-pel | | | | v | v | |
| cross | | | | | | |
| ⅛-pel cross | | | | | v | |

In merge mode, similar search method is applied to the merge candidate indicated by the merge index. As Table 1 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

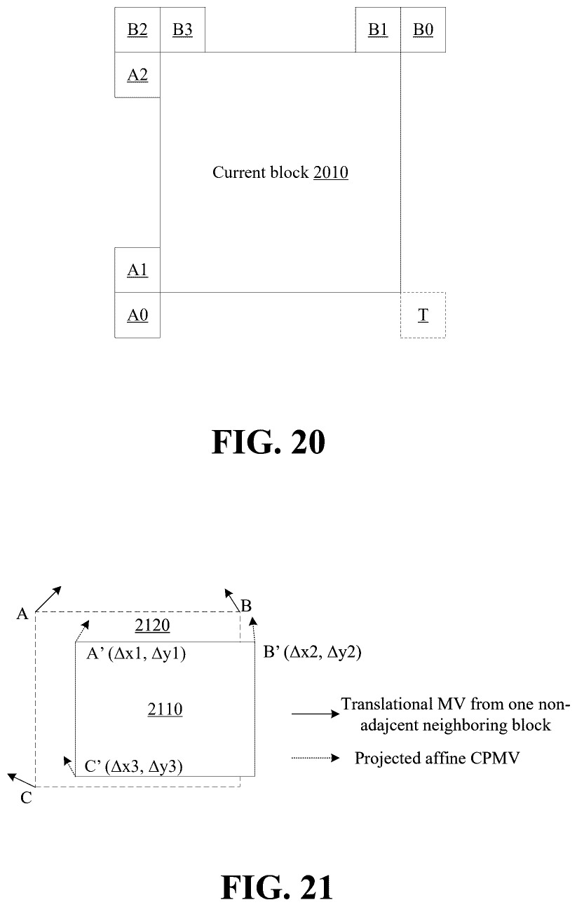

FIG. 14A and FIG. 14B illustrate example diamond search patterns 1400A and 1400B, according to some embodiments of the present disclosure. FIG. 14A is an 8-position diamond search pattern 1400A. In each search round, the current position 1410 is set as the search center and the eight neighboring positions 1420 (the remaining positions shown in FIG. 14A around the current position 1410 are checked, of which the position yields the minimum cost is selected as the next search center. FIG. 14B is 16-position diamond search pattern 1400B, in which 16 neighboring positions 1420 are checked in each search round. The search process is performed is conducted one round by round until it reaches a maximum search round number preset or the search position is over the search range. The early termination algorithm can be adopted. for example, in a search round, if the search center has the minimum cost, the search is terminated.

The sum of absolute difference (SAD) or the sum of absolute transformed difference (SATD) between templates of the current block and the reference block may be used as the template matching cost, i.e., the cost of a candidate motion vector which refers to the reference block. In some other cases, Mean removed SAD or mean removed SATD may be used as the template matching cost. The difference between template of the current block and the template of the reference block.

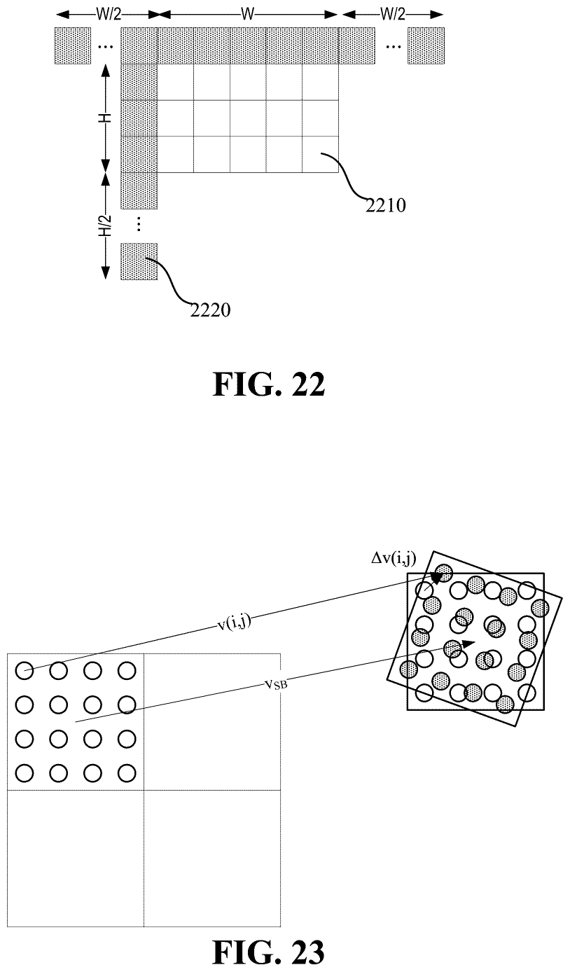

FIG. 15 is a flowchart of a template-based refinement process 1500 for bi-prediction coding blocks, according to some embodiments of the present disclosure. For bi-prediction candidate, the two MVs, one for reference picture list 0 and the other for reference picture list 1, are firstly refined independently and then an iteration process 1500 is performed to jointly refine the two MVs. The process 1500 including steps 1510-1540 is described in FIG. 15.

In step 1510, the initial motion vector of list 0 (MV0) is refined by using TM method to derive a refined MV (MV′0) and a TM cost C0 corresponding to MV′0 is obtained.

In step 1520, the initial motion vector of list 1 (MV1) is refined by using TM method to derive a refined MV (MV′1) and a TM cost C1 corresponding to MV′1 is obtained.

In step 1530, when C0 is larger than C1, MV′1 is fixed and used to derive a further refined MV of list 0 on top of MV′0 by additionally considering the template obtained by MV′1. The refined MV of list 0 in this step is indicated as MV″0. Otherwise, MV′0 is fixed and used to derive a further refined MV of list 1 on top of MV′1 by additionally considering the template obtained by MV′0. The refined MV of list 1 in this step is indicated as MV″1.

In step 1540, when MV of list 0 is refined in step 1530, MV″0 is fixed and used to derive MV of list 1 on top of MV′1 by additionally considering the template obtained by MV″0 to get MV″1. Otherwise, MV″1 is fixed and used to derive MV of list 0 on top of MV′0 by additionally considering the template obtained by MV″1 to get MV″0. The TM cost corresponding to MV″0 and MV″1 is obtained as CostBi.

In the embodiments of FIG. 15, steps 1530 and 1540 may be iterated, and after refining of a bi-prediction, the cost of bi-prediction CostBi will be compared with uni prediction cost C0 or C1. If MV of list 0 is refined in the last step, CostBi is compared with C1 and if MV of list 1 is refined in the last step, CostBi is compared with C0. If CostBi is much larger than uni-prediction cost compared, the current block is converted to a uni-prediction block.

In HEVC, only translation motion model is applied for motion compensation prediction (MCP). While in the real world, there are many kinds of motion, e.g., zoom in/out, rotation, perspective motions and the other irregular motions. In VVC, a block-based affine transform motion compensation prediction is applied.

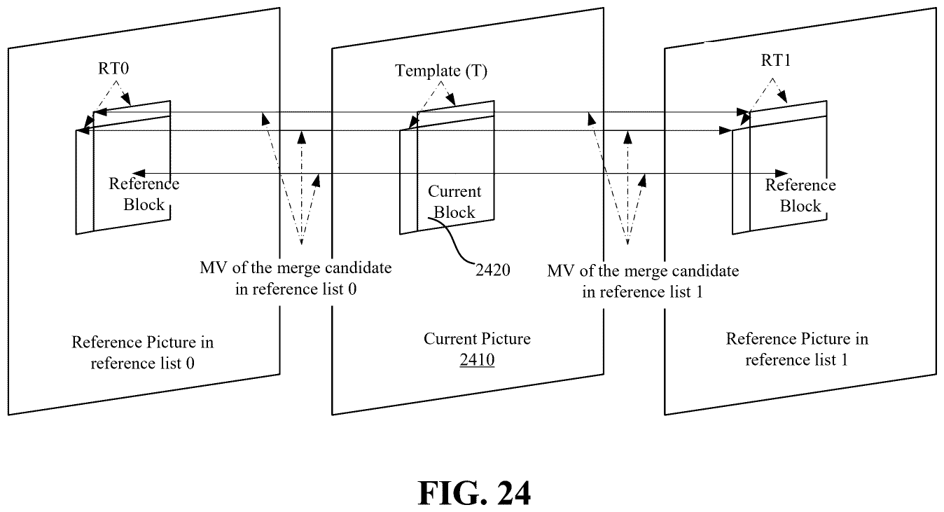

FIG. 16A and FIG. 16B are two schematic diagrams illustrating control-points-based affine model for blocks 1600a and 1600b, according to some embodiments of the present disclosure. In some embodiments, the control points 1610a and 1620a in FIG. 16A and the control points 1610b, 1620b, and 1630b in FIG. 16B are respectively set to the corners of the blocks 1600a and 1600b. As shown FIGS. 16A and 16B, the affine motion field of the block is described by motion information of two control point in 4-parameter affine motion model, or three control point motion vectors in 6-parameter affine motion model. As shown in FIG. 16A, for 4-parameter affine motion model, two control points 1610a and 1620a are needed. As shown in FIG. 16B, for 6-parameter affine motion model, three control points 1610b, 1620b, and 1630b are needed. To reduce the complexity of the model computation and the bandwidth of the motion compensation, the granularity of the affine motion compensation is on subblock level instead of sample level. In some coding standards, 4×4 or 8×8 luma subblock affine motion compensation is adopted, in which each 4×4 subblock or 8×8 subblock has a motion vector to perform motion compensation. To derive motion vector of each 8×8 or 4×4 luma subblock, the motion vector of the center position of each subblock is calculated according to two or three control points (CPs), and rounded to 1/16 fraction accuracy.

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix} \qquad ( 6 )$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 7 )$$

where (mv₀ₓ, mv_{0y}) is motion vector of the top-left corner control point, (mv₁ₓ, mv_{1y}) is motion vector of the top-right corner control point, and (mv2x, mv2y) is motion vector of the bottom-left corner control point. In the above formula 6 and 7, (mv₀ₓ, mv_{0y}) is called base MV of the affine model which defines the translational motion.

$$\frac{{mv}_{1 x} - {mv}_{0 x}}{W} , \frac{{mv}_{2 x} - {mv}_{0 x}}{H} , \frac{{mv}_{1 y} - {mv}_{0 y}}{W} and \frac{{mv}_{2 y} - {mv}_{0 y}}{H}$$

are non-translation parameters of affine model which defines non-translation motions, such as zoom and rotation.

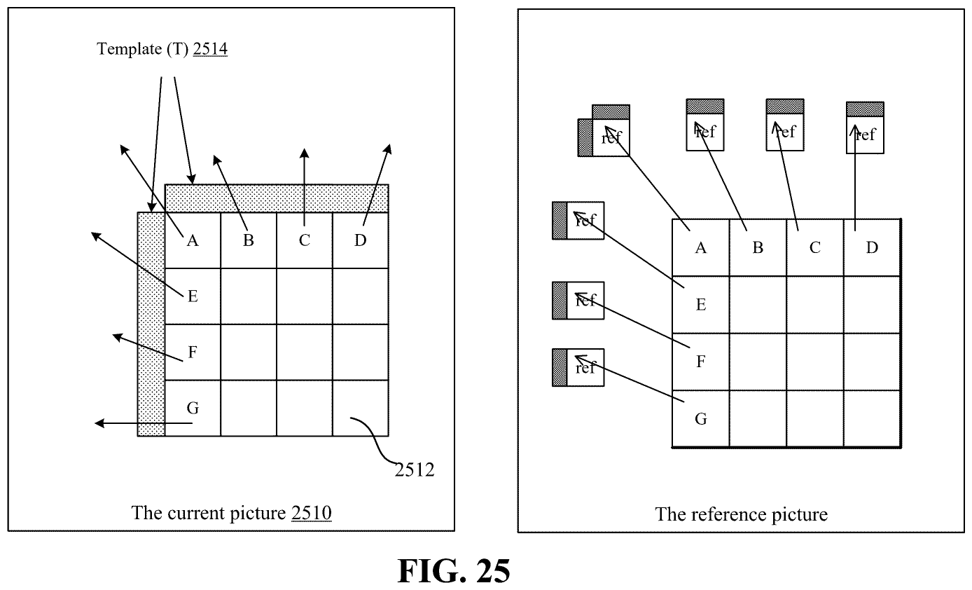

FIG. 17 is a schematic diagram illustrating motion vector of the center sample of each subblock of a block 1700, according to some embodiments of the present disclosure. Particularly, FIG. 17 gives example of four parameters affine model, in which motion vector of each subblock can be derived from the motion vectors MV₁, MV2 of two control points 1710 and 1720. After derivation of subblock motion vector, the motion compensation is performed to generate the predicted block of the subblock with derived motion vector.

In order to simplify the motion compensation prediction, block based affine transform prediction can be applied. To derive motion vector of each 4×4 luma subblock, the motion vector of the center sample of each subblock, as shown in FIG. 17, is calculated according to above equations, and rounded to 1/16 fraction accuracy. In ECM, the subblock size is adaptively decided. If the motion vector difference of two neighboring luma subblock is smaller than a threshold, luma subblocks will be merged into larger subblocks. If the motion vector difference of the larger subblock is still smaller than the threshold, the larger subblock will continue to be merged until the motion vector difference of the two adjacent subblocks is larger than the threshold or until the subblock is equal to the coding unit. Then the motion compensation interpolation filters are applied to generate the prediction of each subblock with derived motion vector. The subblock size of chroma-components is dependent on the size of luma subblock. The MV of a chroma subblock is calculated as the average of the MVs of the top-left and bottom-right luma subblocks in the collocated luma region.

As done for translational motion inter prediction, there are also two affine motion inter prediction modes: affine merge mode and affine AMVP mode.

Affine merge mode (AF_MERGE) can be applied for CUs with both width and height larger than or equal to 8. In this mode the control point motion vectors (CPMVs) of the current CU is generated based on the motion information of the spatial neighboring CUs. There can be up to 15 affine candidates and an index is signaled to indicate the one to be used for the current CU.

In some embodiments, the following 8 types of candidates are used to form the affine merge candidate list: (a) inherited candidates from adjacent neighbors; (b) inherited candidates from non-adjacent neighbors; (c) constructed candidates from adjacent neighbors; (d) the second type of constructed affine candidates from non-adjacent neighbors; (e) the first type of constructed affine candidates from non-adjacent neighbors; (f) regression based affine merge candidate; (g) pairwise affine; and (h) zero MVs.

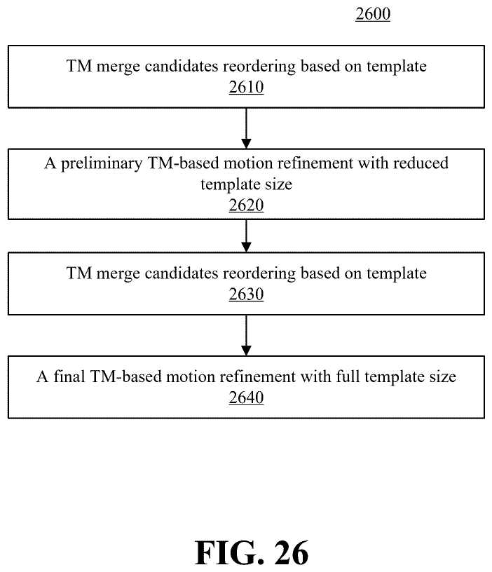

FIG. 18 illustrates control point motion vector inheritance, according to some embodiments of the present disclosure.

The inherited affine candidates are derived from affine motion model of the adjacent or non-adjacent blocks. When an adjacent or non-adjacent affine CU is identified, its control point motion vectors are used to derive the CPMVP candidate in the affine merge list of the current CU 1810. As shown in FIG. 18, if the neighboring left bottom block A is coded in affine mode, the motion vectors v₂, v₃ and v₄ of the top left corner, above right corner and left bottom corner of the CU 1820 which contains the block A are attained. When block A is coded with 4-parameter affine model, the two CPMVs of the current CU 1810 are calculated according to v₂, and v₃. In case that block A is coded with 6-parameter affine model, the three CPMVs of the current CU 1810 are calculated according to v₂, v₃ and v₄.

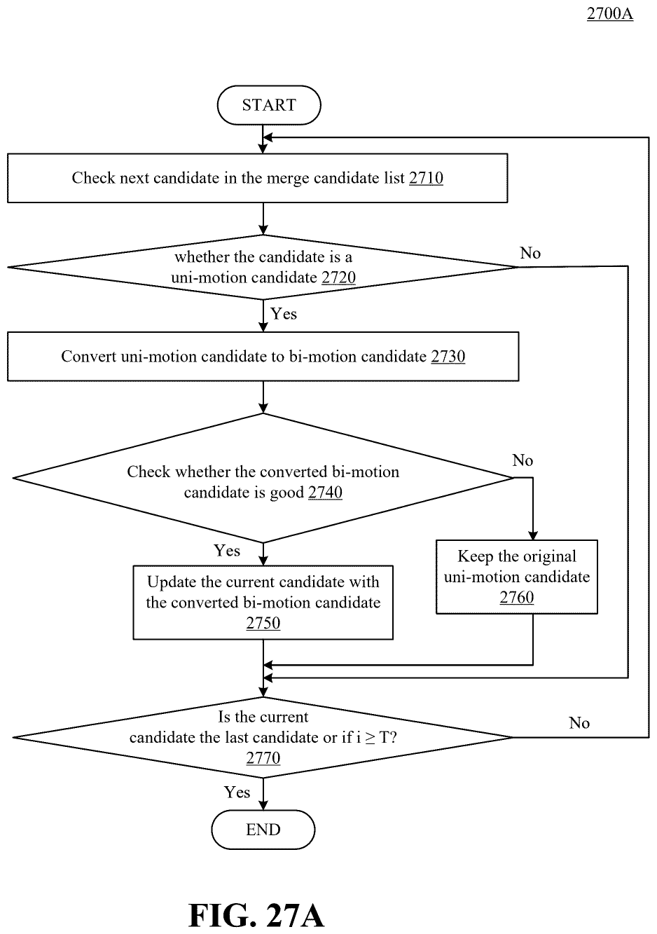

FIG. 19A and FIG. 19B illustrate spatial neighbors for deriving affine merge and affine advanced motion vector prediction (AMVP) candidates, according to some embodiments of the present disclosure. In particular, FIG. 19A illustrates spatial neighbors for deriving inherited candidates, and FIG. 19B illustrates spatial neighbors for deriving the first type of constructed candidates.

For inherited candidates from non-adjacent neighbors in FIG. 19A, the non-adjacent spatial neighbors are checked based on their distances to the current block 1910, i.e., from proximal neighbors to distal neighbors. At a specific distance, only the first available neighbor (that is coded with the affine mode) from each side (e.g., the left and above) of the current block 1910 is included for inherited candidate derivation. As indicated by the dash arrows in FIG. 19A, the checking orders of the neighbors on the left and above sides are bottom-to-up and right-to-left, respectively.

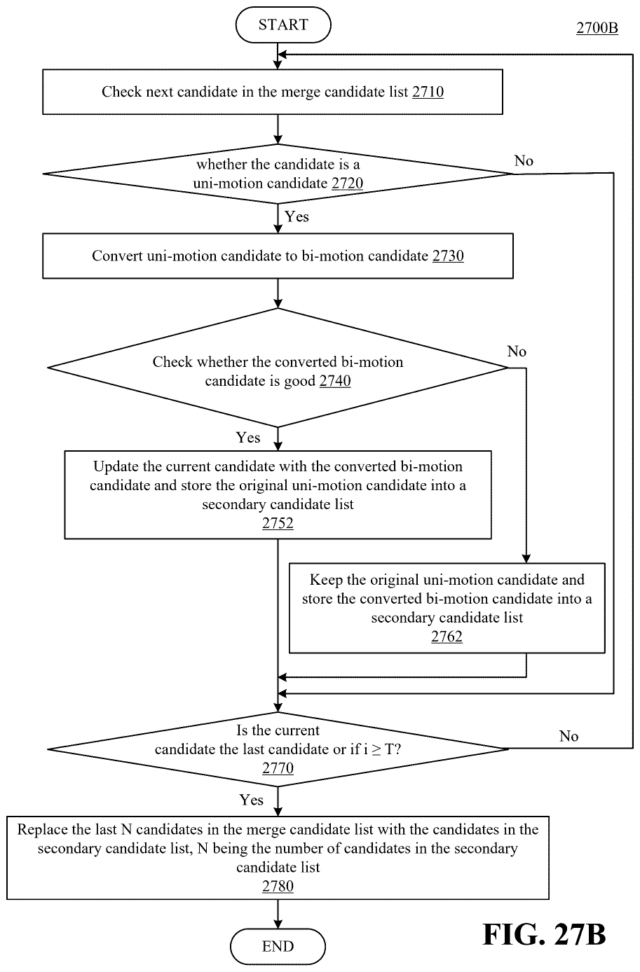

Constructed affine candidates from adjacent neighbors are the candidates constructed by combining the neighbor translational motion information of each control point. FIG. 20 illustrates locations of candidates position for constructed affine merge mode, according to some embodiments of the present disclosure.

The motion information for the control points can be derived from the specified spatial neighbors and temporal neighbor T shown in FIG. 20. CPMVₖ (k=1, 2, 3, 4) represents the k-th control point. For CPMV₁, the B2, B3, A2 blocks are checked and the MV of the first available block is used. For CPMV₂, the B1, B0 blocks are checked and for CPMV₃, the A1, A0 blocks are checked. TMVP can be used as CPMV₄ if it's available.

After MVs of four control points are attained, affine merge candidates are constructed based on those motion information. The following combinations of control point MVs are used to construct in order: {CPMV₁, CPMV₂, CPMV₃}, {CPMV₁, CPMV2, CPMV4}, {CPMV1, CPMV3, CPMV4}, {CPMV2, CPMV3, CPMV4}, {CPMV1, CPMV2}, {CPMV1, CPMV₃}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

For the first type of constructed candidates, as shown in FIG. 19B, the positions of one left and above non-adjacent spatial neighbors are firstly determined independently. After that, the location of the top-left neighbor can be determined accordingly which can enclose a rectangular virtual block together with the left and above non-adjacent neighbors.

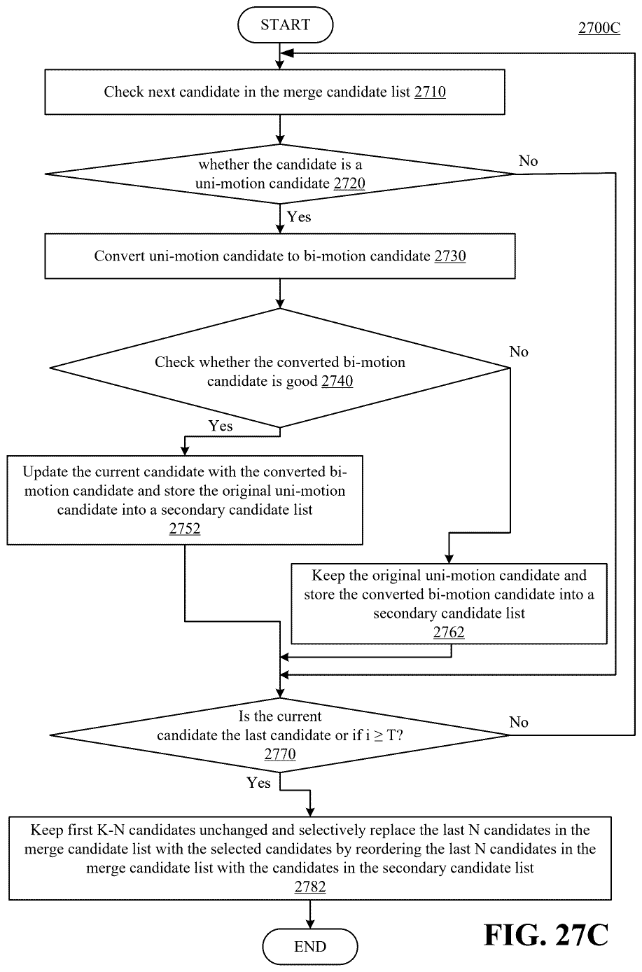

FIG. 21 illustrates a first type of constructed affine merge/AMVP candidates, according to some embodiments of the present disclosure. As shown in the FIG. 21, the motion information of the three non-adjacent neighbors can be used to form the CPMVs at the top-left (A), top-right (B) and bottom-left (C) of the virtual block 2120, which is finally projected to the current CU 2110 to generate the corresponding constructed candidates.

For the second type of constructed candidates, the non-translational affine parameters are inherited from the non-adjacent spatial neighbors. Specifically, the second type of affine constructed candidates are generated from the combination of: (1) the translational affine parameters of adjacent neighboring 4×4 blocks, and (2) the non-translational affine parameters inherited from the non-adjacent spatial neighbors as defined in FIG. 19A.

For the regression based affine merge candidates, Subblock motion field from a previously coded affine CU and motion information from adjacent subblocks of a current CU are used as the input to the regression process to derive proposed affine candidates. The previously coded affine CU can be identified from scanning through non-adjacent positions and the affine HMVP table.

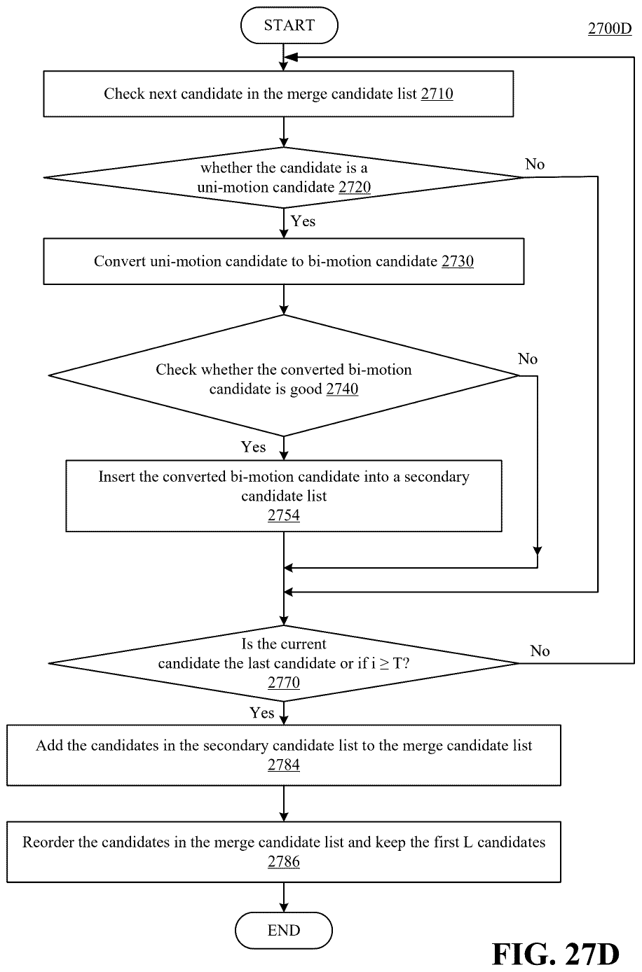

FIG. 22 illustrates neighboring 4×4 subblocks 2220 being used for regression based affine merge candidate derivation, according to some embodiments of the present disclosure. As shown in FIG. 22, 4×4 subblocks 2210 in the current CU are surrounded by neighboring 4×4 subblocks 2220, represented by the grey zone as depicted in FIG. 22. Adjacent subblock information of current CU is fetched from 4×4 subblocks 2220 represented by the grey zone as depicted in FIG. 22. For each subblock, given a reference list, the corresponding motion vector and center coordinate of the subblock may be used. For each affine CU, up to 2 regression based affine candidates can be derived, including one with adjacent subblock information and one without. All the linear-regression-generated candidates are pruned and collected into one candidate sub-group. TM cost based ARMC process is applied when ARMC is enabled. Afterwards, up to N linear-regression-generated candidates are added to the affine merge list when N affine CUs are found.

After inserting all the above candidates into the candidate list, if the list is still not full, zero MVs are inserted to the end of the list.

Next, Prediction refinement with optical flow for affine mode is described. Subblock based affine motion compensation can save memory access bandwidth and reduce computation complexity compared to pixel based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps.

In step 1, the subblock-based affine motion compensation is performed to generate subblock prediction I(i, j).

In step 2, the spatial gradients gₓ(i, j) and g_{y}(i, j) of the subblock prediction are calculated at each sample location using a 3-tap filter [−1, 0, 1]. The gradient calculation can be the same as gradient calculation in BDOF and based on the following equations:

$${g}_{x} ( i , j ) = ( I ( i + 1 , j ) ≫ shift 1 ) - ( I ( i - 1 , j ) ≫ shift 1 ) \qquad ( 8 )$$

$${g}_{y} ( i , j ) = ( I ( i , j + 1 ) ≫ shift 1 ) - ( I ( i , j - 1 ) ≫ shift 1 ) \qquad ( 9 )$$

shift1 is used to control the gradient's precision. The subblock (i.e., 4×4) prediction is extended by one sample on each side for the gradient calculation. To avoid additional memory bandwidth and additional interpolation computation, those extended samples on the extended borders are copied from the nearest integer pixel position in the reference picture.

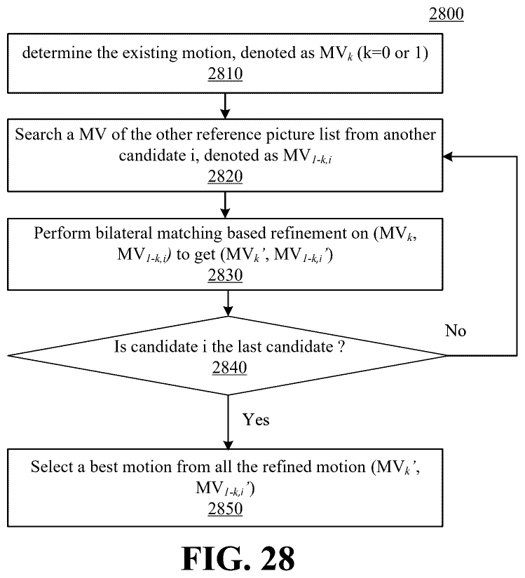

In step 3, the luma prediction refinement is calculated by the following optical flow equation:

$$Δ I ( i , j ) = {g}_{x} ( i , j ) * Δ {v}_{x} ( i , j ) + {g}_{y} ( i , j ) * Δ {v}_{y} ( i , j ) \qquad ( 10 )$$

where the Δv(i, j) is the difference between sample MV computed for sample location (i, j), denoted by v(i, j), and the subblock MV of the subblock to which sample (i, j) belongs, as shown in FIG. 23. FIG. 23 illustrates subblock MV V_{SB} and pixel Δv(i,j), according to some embodiments of the present disclosure. The Δv(i, j) is quantized in the unit of 1/32 luma sample precision.

Since the affine model parameters and the sample location relative to the subblock center are not changed from subblock to subblock, Δv(i, j) can be calculated for the first subblock, and reused for other subblocks in the same CU. Let dx(i, j) and dy(i, j) be the horizontal and vertical offset from the sample location (i, j) to the center of the subblock (x_{SB}, y_{SB}), Δv(x, y) can be derived by the following equations:

$$\{ \begin{matrix}dx ( i , j ) = i - {x}_{SB} \\ dy ( i , j ) = j - {y}_{SB}\end{matrix} \qquad ( 11 )$$

$$\{ \begin{matrix}Δ {v}_{x} ( i , j ) = C * dx ( i , j ) + D * dy ( i , j ) \\ Δ {v}_{y} ( i , j ) = E * dx ( i , j ) + F * dy ( i , j )\end{matrix} \qquad ( 12 )$$

In order to keep accuracy, the center of the subblock (x_{SB}, y_{SB}) is calculated as ((WSB−1)/2, (HSB−1)/2), where WSB and HSB are the subblock width and height, respectively. For 4-parameter affine model, the coefficients C, D, E, and F are calculated based on the following equations:

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad ( 13 )$$

For 6-parameter affine model, the coefficients C, D, E, and F are calculated based on the following equations:

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad ( 14 )$$

where (v₀ₓ, v_{0y}), (v₁ₓ, v_{1y}), (v₂ₓ, v_{2y}) are the top-left, top-right and bottom-left control point motion vectors, w and h are the width and height of the CU.

In step 4, finally, the luma prediction refinement ΔI(i, j) is added to the subblock prediction I(i, j). The final prediction I′ is generated as the following equation.

$${I}^{′} ( i , j ) = I ( i , j ) + Δ I ( i , j )$$

PROF is not applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.

The merge candidates are adaptively reordered with template matching (TM). The reordering method is applied to regular merge mode, TM merge mode, and affine merge mode (excluding the SbTMVP candidate).

An initial merge candidate list is firstly constructed according to given checking order, such as spatial, temporal motion vector predictors (TMVPs), non-adjacent, history-based motion vector predictors (HMVPs), pairwise, virtual merge candidates. Then the candidates in the initial list are divided into several subgroups. Merge candidates in each subgroup are reordered to generate a reordered merge candidate list and the reordering is according to cost values based on template matching. The index of selected merge candidate in the reordered merge candidate list is signaled to the decoder. For simplification, merge candidates in the last but not the first subgroup are not reordered. All the zero candidates from the ARMC reordering process are excluded during the construction of Merge motion vector candidates list. The subgroup size is set to 5 for regular merge mode and TM merge mode. The subgroup size is set to 3 for affine merge mode.

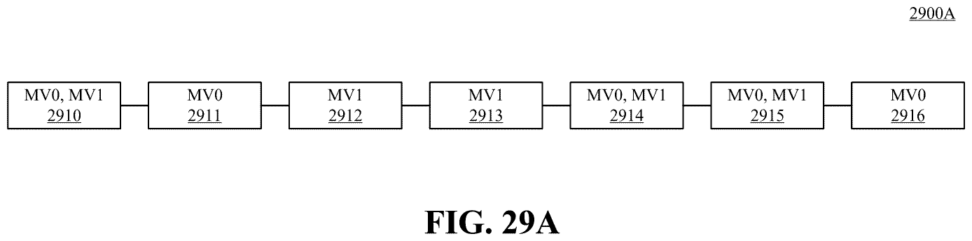

FIG. 24 illustrates a template and reference samples of the template in reference pictures, according to some embodiments of the present disclosure. As shown in FIG. 24, reference samples RT0 are the reference samples of the template T in reference list 0, and reference samples RT1 are the reference samples of the template T in reference list 1.

The template matching cost of a merge candidate during the reordering process is measured by the SAD between samples of a template of the current block and their corresponding reference samples. The template T includes a set of reconstructed samples neighboring to the current block 2420 of the current picture 2410. Reference samples RT0, RT1 of the template T are located by the motion information of the merge candidate. When a merge candidate utilizes bi-directional prediction, the reference samples RT0, RT1, of the template T of the merge candidate are also generated by bi-prediction as shown in FIG. 24.

When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

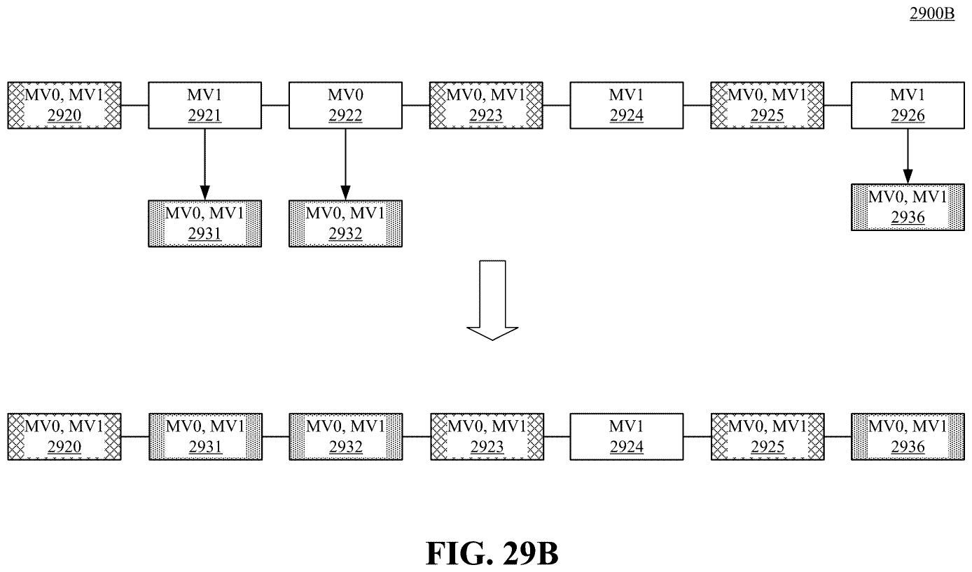

For affine merge candidates with subblock size equal to Wsub×Hsub, the above template includes several sub-templates with the size of Wsub×1, and the left template includes several sub-templates with the size of 1×Hsub. FIG. 25 illustrates a template 2514 and reference samples of the template for block with subblock motion using the motion information of the subblocks A-G of the current block 2512, according to some embodiments of the present disclosure. As shown in FIG. 25, the motion information of the subblocks A-G in the first row and the first column of current block 2512 of the current picture 2510 is used to derive the reference samples of each sub-template.

In the reordering process, a candidate is considered redundant if the cost difference between a candidate and its predecessor is inferior to a lambda value, e.g., |D1−D2|<λ, where D1 and D2 are the costs obtained during the first ARMC ordering and A is the Lagrangian parameter used in the RD criterion at encoder side.

The proposed algorithm is defined as the following. First, the minimum cost difference between a candidate and its predecessor among all candidates in the list is determined. If the minimum cost difference is superior or equal to 2, the list is considered diverse enough and the reordering stops. If this minimum cost difference is inferior to λ, the candidate is considered redundant, and moved at a further position in the list. This further position is the first position where the candidate is diverse enough compared to its predecessor. The algorithm stops after a finite number of iterations (if the minimum cost difference is not inferior to λ).

This algorithm can be applied to the regular, TM, BM and affine merge modes. A similar algorithm can be applied to the merge MMVD and sign MVD prediction methods which also use ARMC for the reordering.

The value of λ is set equal to the λ of the rate distortion criterion used to select the best merge candidate at the encoder side for low delay configuration and to the value A corresponding to a another QP for Random Access configuration. A set of λ values corresponding to each signaled QP offset is provided in the SPS or in the Slice Header for the QP offsets which are not present in the SPS.

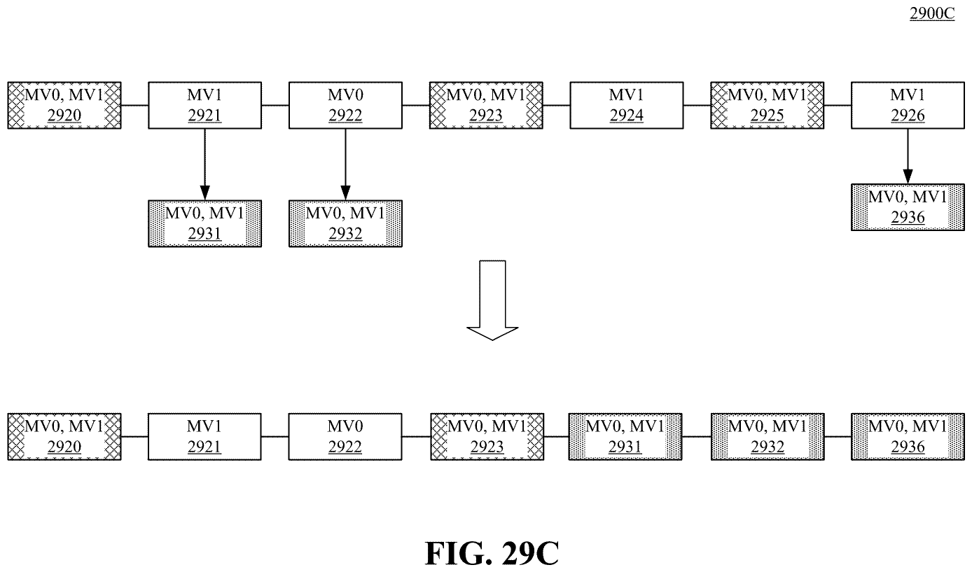

The template-based reorder is also applied on TM merge mode. FIG. 26 is a flowchart of a template-based reordering and template-based motion refinement process 2600, according to some embodiments of the present disclosure. As shown in FIG. 26, at step 2610, the TM merge candidates are reordered before the TM refinement process. At step 2620, a preliminary TM based refinement is conducted with reduced size of template. At step 2630, another TM based reordering is performed. At step 2640, the final TM based refinement is performed with full size of template. In the preliminary TM based refinement, if multi-pass DMVR is used, only the first pass (i.e., PU level) of multi-pass DMVR is applied, and in the final TM based refinement, both PU level and subblock level of multi-pass DMVR are applied.

The ARMC design is also applicable to the AMVP mode wherein the AMVP candidates are reordered according to the TM cost. For the template matching for advanced motion vector prediction (TM-AMVP) mode, an initial AMVP candidate list is constructed, followed by a refinement from TM to construct a refined AMVP candidate list. In addition, an MVP candidate with a TM cost larger than a threshold, which is equal to five times of the cost of the first MVP candidate, is skipped.

It is noted that when wrap around motion compensation is enabled, the MV candidate shall be clipped with wrap around offset taken into consideration.

Merge candidates of one single candidate type, e.g., TMVP or non-adjacent MVP (NA-MVP), are reordered based on the ARMC TM cost values. The reordered candidates are then added into the merge candidate list. The TMVP candidate type adds more TMVP candidates with more temporal positions and different inter prediction directions to perform the reordering and the selection. Moreover, NA-MVP candidate type is further extended with more spatially non-adjacent positions. The target reference picture of the TMVP candidate can be selected from any one of reference picture in the list according to scaling factor. The selected reference picture is the one whose scaling factor is the closest to 1.

In practice, the above-described video coding techniques still have some problems that call for improvement. The DMVR or the multi-pass DMVR can be applied on regular mode and affine merge mode. As the motion derived in the merge mode are inherited from previously coded blocks and may not match well with the current block, DMVR can improve the accuracy of the motion derived in the merge mode. However, because BM is used in DMVR process, it can only be applied to the block which is uni-predicted. That is to say, DMVR can only be applied to the merge candidate with uni-prediction motion. Thus, for the uni-motion candidate, it cannot be refined and the motion may still be inaccurate. Besides DMVR, bi-prediction with optical flow (BDOF) and other coding technologies which applied on the bi-prediction block may not be used for uni-prediction block.

The present disclosure provides methods for solve one or more the above-described problems. In some embodiments of the present disclosure, methods for the decoder side motion refinement for uni-prediction is provided. In various embodiments of the present disclosure, it is proposed to apply decoder side motion refinement on uni-prediction block by converting uni-prediction to bi-prediction. That is, the candidate with uni-motion (i.e., a candidate only with MV of RPL0 or only with MV of PRL1) can be converted to a candidate with bi-motion, so that all the coding tools applicable to the bi-prediction block can be applied to the candidate. The conversion process can be realized with a search process which is conducted both at the encoder and decoder side. For example, it can be a bilateral matching (BM) based motion search.

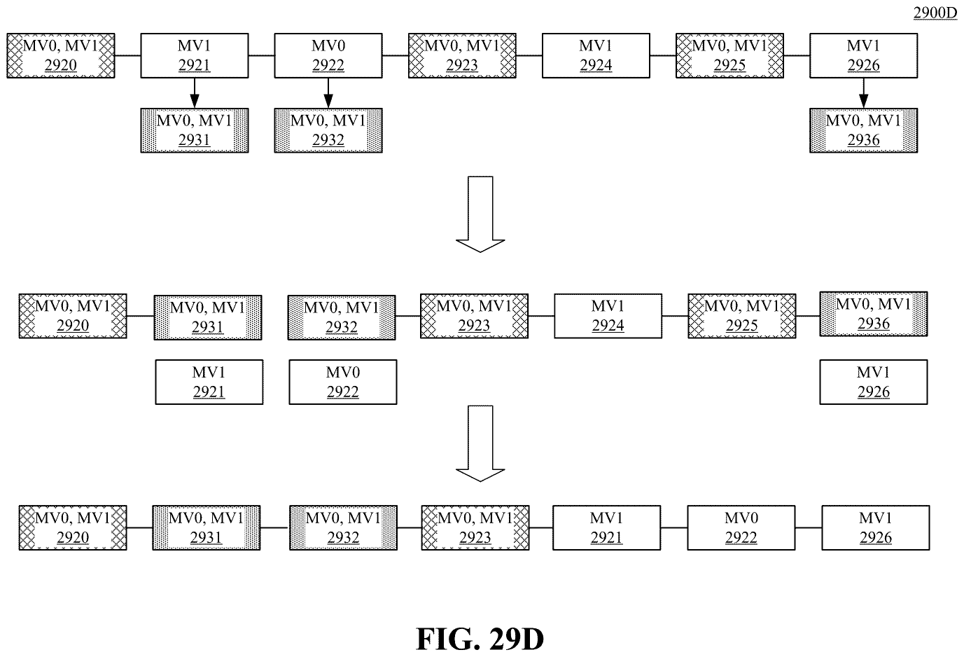

In some embodiments, a merge list conversion can be performed. FIG. 27A is a flowchart of an example merge candidate list conversion process 2700A, according to some embodiments of the present disclosure.

In some embodiments, all the merge candidates with uni-motion in the merge candidate list are checked right after merge candidate list is constructed. Then the conversion is applied to each of the merge candidate with uni-motion if the converted bi-motion is better than original uni-motion. After conversion, the existing merge candidate list refinement methods, such as adaptive reordering of merge candidate, DMVR, TM based refinement are applied to merge candidate list with converted candidates. In some embodiments, the process 2700A can be applied to all the candidate with uni-motion in both encoder and decoder side.

As shown in FIG. 27A, right after the merge candidate list is constructed, each candidate in the merge list can be checked, and a motion conversion for a candidate from the merge candidate list can be performed. At step 2710, a next candidate in the merge candidate list becomes a current candidate and is checked. At step 2720, whether the candidate is a uni-motion candidate is determined. If the current candidate is a uni-motion candidate (step 2720—yes) (i.e., a candidate only having RPL0 mv or RPL1 mv), the conversion process including steps 2730-2760 is invoked. Otherwise (step 2720—no), steps 2730-2760 are skipped, and step 2770 is performed. At step 2730, in response to the candidate being the uni-motion candidate, the uni-motion candidate is converted to a bi-motion candidate.

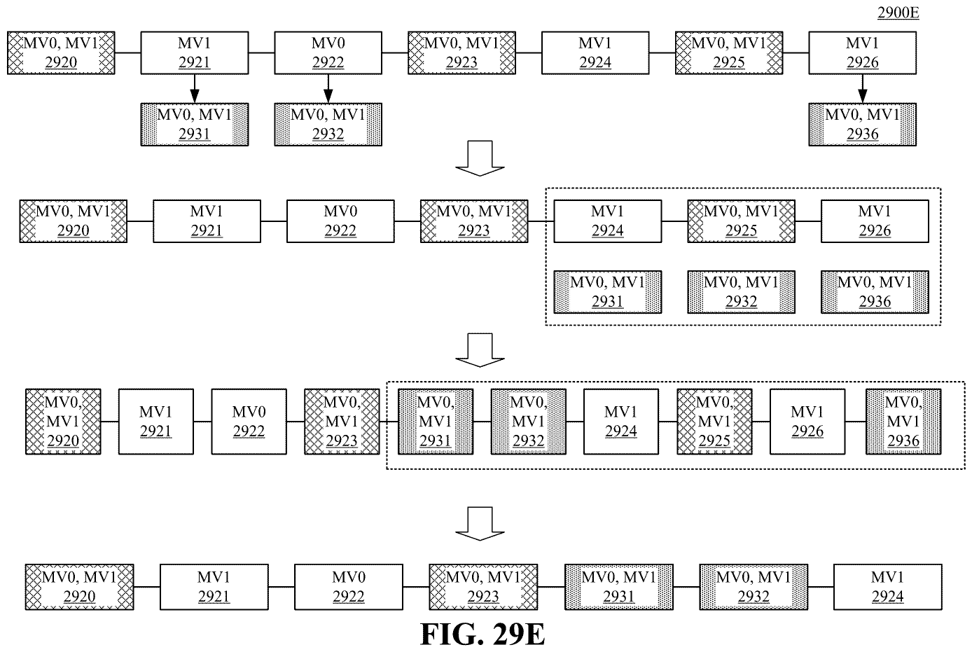

FIG. 28 is a flowchart of an example conversion process 2800 to convert a uni-motion candidate to a bi-motion candidate, according to some embodiments of the present disclosure. At step 2810, the existing motion, denoted as MVₖ (k=0 or 1), is determined. At step 2920, a MV of the other reference picture list from another candidate i, denoted as MV_{1-k,j} is searched. In the conversion process 2800 as shown in FIG. 28, the existing motion is determined first and then the motion of the other RPL is searched from the other candidates in the merge list. For example, if a candidate only has MV of RPL0 (denoted as MV₀), the MV₀ is the existing motion and the MV of RPL1 (denoted as MV₁) is to be searched.

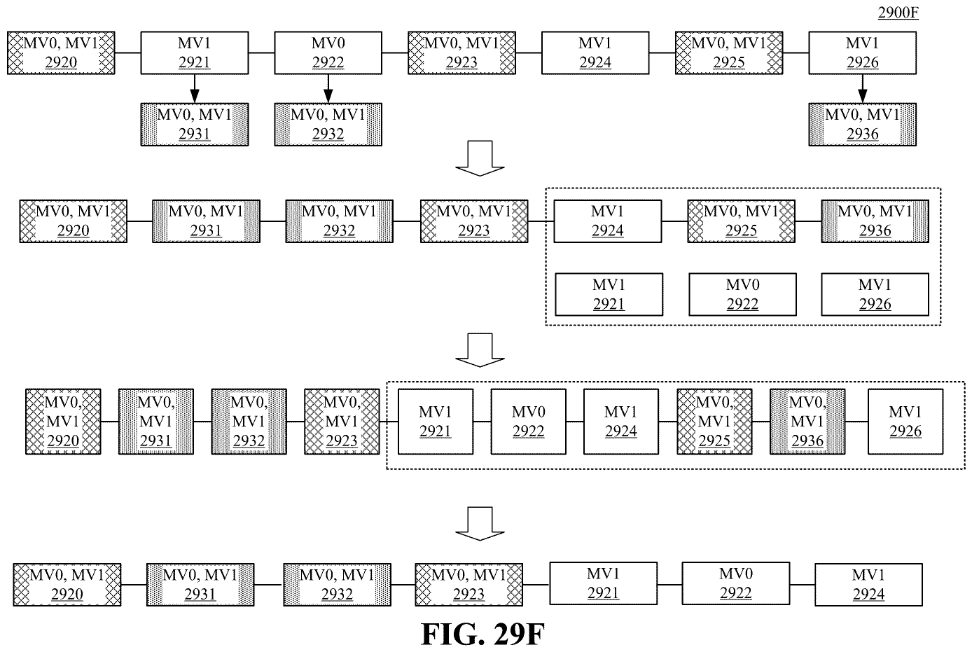

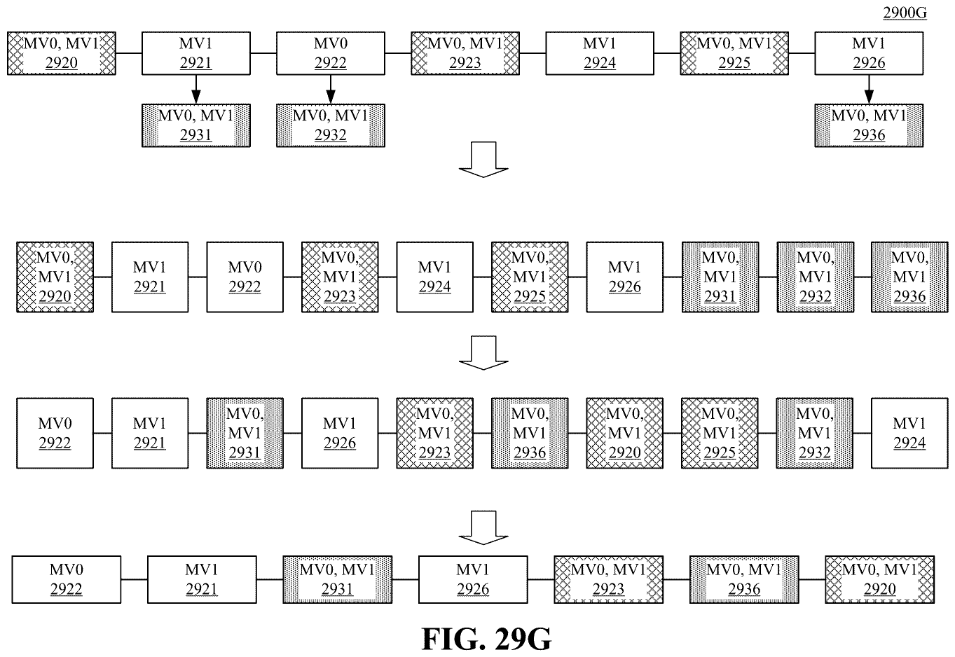

FIG. 29A is a schematic diagram illustrating an example merge candidate list 2900, according to some embodiments of the present disclosure. In FIG. 29A, there are seven motion candidates 2910-2916 in the merge candidate list 2900A. As shown in FIG. 29, candidate 2910 is a bi-motion candidate with MV₀ and MV₁, candidate 2911 is a uni-motion candidate with only MV₀ (MV of RPL0), candidate 2912 and candidate 2913 are uni-motion candidates with only MV₁ (MV of RPL1), candidate 2914 and candidate 2915 are a bi-motion candidates with MV₀ and MV₁, and candidate 2916 is a uni-motion candidate with only MV₀. Assume the current candidate is candidate 2911 which only has MV₀ (MV of RPL0) ( ), and MV₁ (MV of RPL1) of the current candidate is to be obtained from other candidates having MV₁ (i.e., candidate 2910, candidate 2912, candidate 2913, candidate 2914 and candidate 2915). So MV₁ of candidate 2910, candidate 2912, candidate 2913, candidate 2914 and candidate 5 is obtained one by one, denoted as MV_{1,0}, MV_{1,2}, MV_{1,3}, MV_{1,4}, MV_{1,5} respectively, as the initial MV of RPL1 for the current candidate.

Then, at steps 2830 and 2840, bilateral matching based refinement is performed on (MVₖ, MV_{1-k,i}) to get (MVₖ′, MV_{1-k,i}′) until candidate i is the last candidate. For example, the BM based refinement is performed on the current candidate with (MV₀, MV_{1,i}) (i=0, 2, 3, 4, 5), to get (MV₀′, MV_{1,i}′) (i=0, 2, 3, 4, 5).

Then, at step 2850, a best motion is selected from all the refined motion (MVₖ′, MV_{1-k,i}′). In other words, for each of i, a best refined motion vector pair is selected. That is, among the refined motion vector pairs (MV₀′, MV_{1,0}′), (MV0′, MV_{1,2}′), (MV0′, MV_{1,3}′), (MV0′, MV_{1,4}′) and (MV0′, MV_{1,5}′), the pair producing the minimum BM cost can be selected as the converted bi-motion.

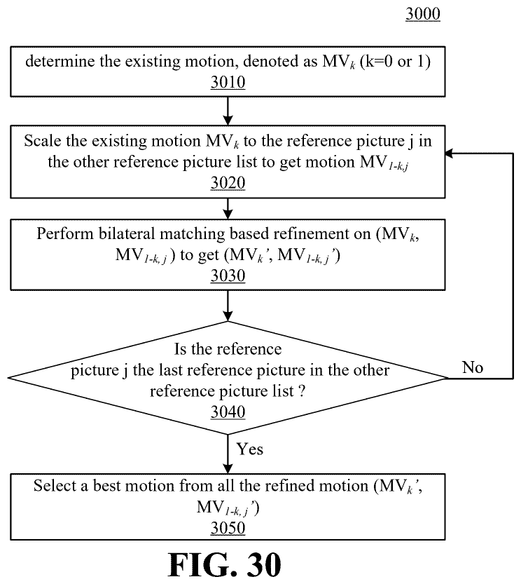

In some other examples, the motion of the other reference picture list is not obtained from other candidates, but is derived by scaling the existing motion to the reference picture of the other reference picture list, which is shown as in FIG. 30. FIG. 30 is a flowchart of an example conversion process 3000 to convert a uni-motion candidate to a bi-motion candidate, according to some embodiments of the present disclosure.

At step 3010, the existing motion, denoted as MVₖ (k=0 or 1), is determined. For example, the current candidate only has MV of RPL0 (denoted as MV₀), the MV₀ is the existing motion and the MV of RPL1 (denoted as MV₁) is to be searched.

At step 3020, the existing motion MVₖ is Scaled to the reference picture j in the other reference picture list to get motion MV_{1-k,j}. For example, in the RPL1, there are 2 reference pictures, denoted as p0 and p1. So MV₀ is scaled to the reference picture p0 and p1 to get MV_{1,0} and MV_{1,1}, respectively. MV_{1,0} and MV_{1,1} are set as initial RPL1 motion of the current candidate.

Then, at steps 3030 and 3040, bilateral matching based refinement is performed on (MVₖ, MV_{1-k, j}) to get (MVₖ′, MV_{1-k, j}′) until the reference picture j is the last reference picture in the other reference picture list. For example, BM based refinement is performed on the current candidate with (MV₀, MV_{1,j}) (j=0, 1), to get (MV₀′, MV_{1,j}′).

Then, at step 3050, a best motion is selected from all the refined motion (MVₖ′, MV_{1-k, j}′). In other words, for each of j, a best refined motion vector pair can be selected. That is, among the refined motion vector pairs (MV₀′, MV_{1,0}′) and (MV0′, MV_{1,1}′), the motion vector pair producing the minimum BM cost can be selected as the converted bi-motion.

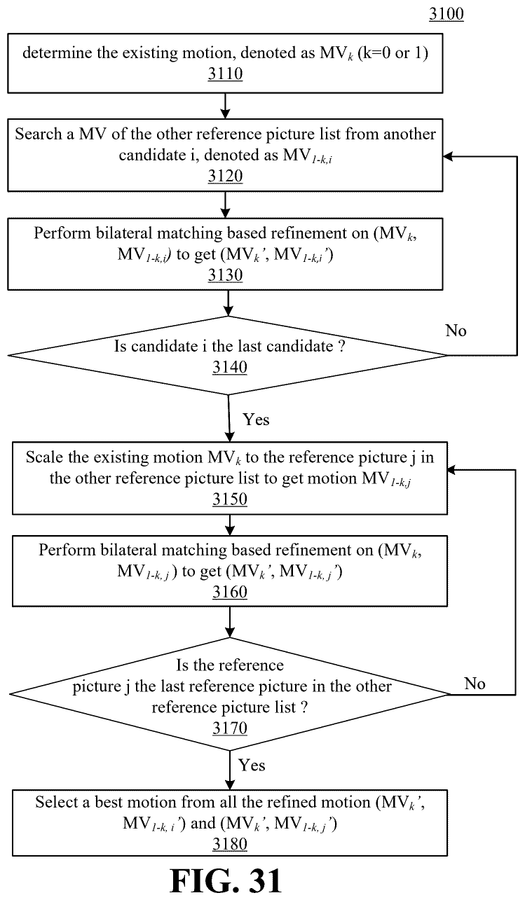

In some other examples, the two methods in FIG. 28 and FIG. 30 to get the initial motion of the other RPL can be combined, which is shown in FIG. 31. FIG. 31 is a flowchart of an example conversion process 3100 to convert a uni-motion candidate to a bi-motion candidate, according to some embodiments of the present disclosure. In conversion process 3100, steps 3110-3140 correspond to steps 2810-2840 of the conversion process 2800, and steps 3150-3170 correspond to steps 3020-3040 of the conversion process 3000, and thus detailed discussion are not repeated herein for the sake of brevity. Then, at step 3180, a best motion is selected from all the refined motion (MVₖ′, MV_{1-k, i}′) and (MVₖ′, MV_{1-k, j}′).

To reduce the complexity, before BM based refinement, the MV similarity is checked. The BM based refinement is applied only when the current MV pair is not similar with the previous MV pairs which are already refined. For example, as in FIG. 29A, candidate 2910 is a bi-motion candidate with MV₀ and MV₁, candidate 2911 is a uni-motion candidate with only MV₀ (MV of RPL0), candidate 2912 and candidate 2913 are uni-motion candidates with only MV₁ (MV of RPL1), candidate 2914 and candidate 2915 are a bi-motion candidates with MV₀ and MV₁, and candidate 2916 is a uni-motion candidate with only MV₀. Suppose the current candidate is candidate 2911 which only has MV₀ (MV of RPL0), and MV₁ (MV of RPL1) of the current candidate is to be obtained from other candidates having MV of RPL1 (i.e., candidate 0, candidate 2, candidate 3, candidate 4 and candidate 5). So MV₁ of candidate 0, candidate 2, candidate 3, candidate 4 and candidate 5, denoted as MV_{1,0}, MV_{1,2}, MV_{1,3}, MV_{1,4}, MV_{1,5}, are to be searched. First, BM based refinement is applied on MV pair (MV₀, MV_{1,0}) to get (MV₀′, MV_{1,0}′). Then, before the next BM based refinement, MV similarity check is performed. That is, MV pair (MV₀, MV_{1,2}) is compared with (MV₀, MV_{1,0}). If the difference between MV_{1,0} and MV_{1,2} is less than a threshold, MV pair (MV₀, MV_{1,2}) is determined to be similar with (MV₀, MV_{1,0}), the BM based refinement is skipped for MV pair (MV₀, MV_{1,2}). And after that, MV similarity check is performed on (MV₀, MV_{1,3}). If the difference between MV_{1,0} and MV_{1,3} is larger than a threshold, MV pair (MV₀, MV_{1,3}) is determined to be not similar with (MV₀, MV_{1,0}), the BM based refinement is performed on MV pair (MV₀, MV_{1,3}) to get (MV₀′, MV_{1,3}′). Then, MV similarity check is performed on (MV₀, MV_{1,4}). MV_{1,4} is compared with MV_{1,0} and MV_{1,3}. If the difference between MV 1,4 and MV_{1,0} is less than a threshold or the difference between MV_{1,4} and MV_{1,3} is less than a threshold, MV pair (MV₀, MV_{1,4}) is determined to be similar with MV pair (MV₀, MV_{1,0}) or MV pair (MV₀, MV_{1,3}); otherwise MV pair (MV₀, MV_{1,4}) is determined to be not similar with MV pair (MV₀, MV_{1,0}) or MV pair (MV₀, MV_{1,3}). And the BM based refinement is only performed on MV pair (MV₀, MV_{1,4}) to get (MV₀′, MV_{1,4}′) when MV pair (MV₀, MV_{1,4}) is determined to be not similar. By doing this, the BM based refinement is not always performed. And dependent on the MV similarity, some BM based refinement can be skipped.

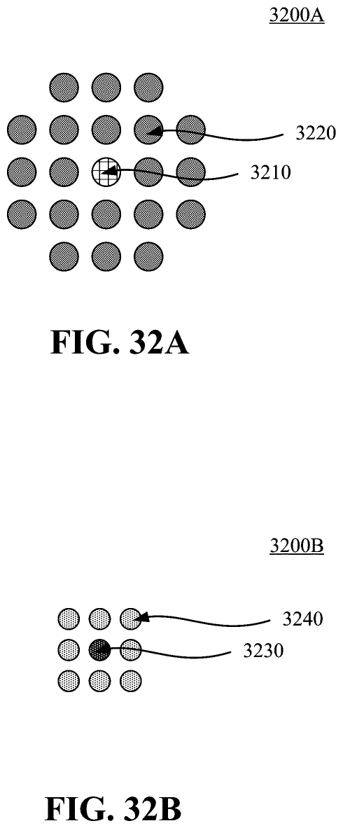

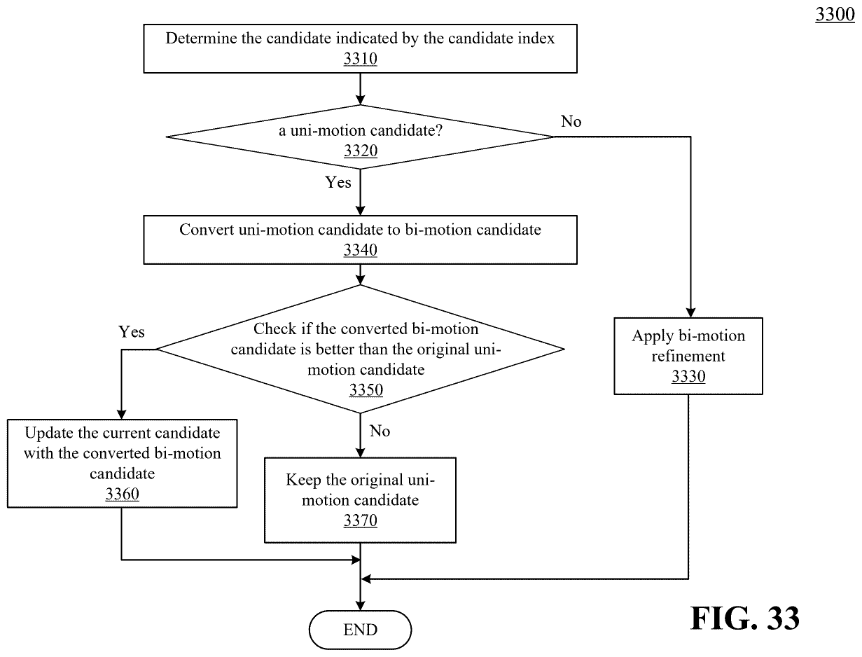

For the bilateral matching base refinement, the current DMVR method or adaptive DMVR method can be applied. In one example, the original uni-motion MV₀ is fixed, and the other motion MV_{1,i} is searched. For each search position, it is equivalent to add a corresponding offset to the MV_{1,i}, denoted as MV_{ioffset}, the predictor blocks which are referred to by the MV₀ and MV_{1,i}+MV_{ioffset} are obtained respectively. And then the SAD or the SATD between these two predictor blocks is calculated as the BM cost of (MV₀, V_{1,i}+MV_{ioffset}). The motion vector position producing the minimum BM cost is chosen as the converted bi-motion candidate denoted as (MV0′, MV_{1,i}′) where MV0′ may be equal to MV0, as MV0 is fixed and only MV1 is searched. In another example, both MV₀ and MV_{1,i} are searched. The symmetrical search criterion can be applied. That is, for each search position, if a corresponding MV offset is added to one motion, the same MV offset is subtracted from the other motion. Accordingly, for each position, the corresponding MV pair can be denoted as (MV₀−MV_{ioffset}, MV_{1,i}+MV_{ioffset}). BM cost is calculated as the SAD or SATD between the predictor block referred to by MV₀−MV_{ioffset} and the predictor block referred to by MV_{1,i}+MV_{ioffset}. The motion vector pair producing the minimum BM cost is chosen as the converted bi-motion candidate denoted as (MV0′, MV_{1,i}′). For the search pattern, all the search patterns, such as square search, cross search as shown in FIG. 11, FIG. 12 and FIGS. 14A and 14B, or FIGS. 32A and 32B below can be used.

FIG. 32A illustrates an integer template matching (TM) search pattern 3200A, according to some embodiments of the present disclosure. FIG. 32B illustrates a half-pixel TM search pattern 3200B, according to some embodiments of the present disclosure. In some embodiments, all the search patterns, including cross search, 8-position diamond search, 16-position diamond search pattern can be used. For example, as shown FIG. 32A, to reduce the search complexity, in the integer TM search pattern 3200A, the circle 3210 is the initial position and only the 20 positions around the initial position (i.e., the remaining circles 3220 in FIG. 32A) are searched. The position with the minimum TM cost is obtained as the best position in the integer search and it is set as the initial position in the following fractional search process. As shown in FIG. 32B, to reduce the complexity, the circle 3230 is the best integer position obtained in the integer search process, and the 8 half-pixel positions around the best integer position (i.e., the remaining circles 3240 in FIG. 32B) are searched in the fractional search pattern 3200B. The position with the minimum TM cost is obtained as the best position in the fractional search and output as the optimal position and the corresponding MV is referred as the refined MV.

Referring again to FIG. 27A, after the conversion process at step 2730, as shown in FIG. 27A, a comparison is performed to determine whether keep the converted bi-motion candidate or revert to the original uni-motion candidate. At step 2740, whether to update the uni-motion candidate with the bi-motion candidate can be determined by checking whether the converted bi-motion candidate is good. In some embodiments, if the converted bi-motion candidate (MV₀′, MV₁′) is not good (step 2740—no), at step 2760, the conversion is reverted.

That is, the original uni-motion candidate is kept. If the converted bi-motion candidate (MV₀′, MV₁′) is good (step 2740—yes), at step 2750, the converted bi-motion candidate (MV₀′, MV₁′) is kept. That is, the current candidate is updated with the converted bi-motion.

There can be different methods to check whether the converted bi-motion candidate is good or not. For example, the original motion MV₀ can be compared with the converted motion (MV₀′, MV₁′) with TM cost. That is, the template of the reference block referred to by MV₀ is obtained (named reference template). And the TM cost, denoted TM_{orignal}, is calculated as the SAD or SATD between the reference template and the current template which consists of the neighboring reconstructed samples of the current coding block. Then the templates of reference blocks referred to by MV₀′ and MV₁′ are obtained respectively and weighted averaged to get a reference template. The TM cost, denoted as TM_{refined}, is calculated as the SAD or SATD between the weighted averaged reference template and the current template. If the TM_{orignal} is less than TM_{refined}, the converted bi-motion is not good, and the original uni-motion candidate with MV₀ is kept for the current candidate; if TM_{refined} is less than TM_{orignal}, the converted bi-motion (MV₀′, MV₁′) is good, and the current candidate is updated with bi-motion candidate (MV₀′, MV₁′). In another example, BM cost of the converted bi-motion candidate is compared with a threshold. That is, if the BM cost which is calculated as the SAD or SATD between two predicted blocks respectively referred to by the MV₀′ and MV₁′ is less than the threshold TH, the converted bi-motion candidate (MV₀′, MV₁′) is good and the candidate is converted to bi-motion candidate with motion of (MV₀′, MV₁′); otherwise, the converted bi-motion candidate is not good, and the original uni-motion candidate with MV₀ is kept. In another example, the BM cost of the converted bi-motion candidate is compared with the BM cost of other original bi-motion candidates in the merge list. So, first, the BM cost of each bi-motion candidate before conversion (not including the converted bi-motion candidates) is calculated and the minimum one among all the BM costs of original bi-motion candidates is denoted as BMₘ. Then the BM cost of the current converted bi-motion candidate (denoted as BM_{c}) is compared with BMₘ. If BM_{c}<TH*BMₘ where TH is a scaling factor, the current converted bi-motion candidate is good and the original uni-motion candidate is replaced with this converted bi-motion candidate; otherwise, the current converted bi-motion candidate is not good, the original uni-motion candidate is kept. The scaling factor TH can be any position value.

As shown in FIG. 27A, in some embodiments, if the current candidate is not the last candidate (step 2770—no), steps 2710-2760 are repeated, until each candidate in the merge list are checked. If the current candidate is the last candidate (step 2770—yes), the motion conversion process 2700A is completed. In some other embodiments, to reduce the complexity, not all the uni-motion candidates in the merge candidate list are converted. A maximum number T of uni-motion candidates to be converted is set. Both the encoder and decoder check the candidate one by one and only the first T candidates (or first T uni-motion candidates) are converted. So, in that case, if the candidate selected by the encoder is not the one in the first T candidates, the decoder can skip the conversion process. In other words, if an index i of the candidate is smaller than the preset maximum number T (step 2770—no), steps 2710-2760 are repeated, until the index i reaches the preset maximum number T (step 2770—yes).

There may be three options to control the converted candidate number. In the first option, for each candidate, the value of the index i is incremented by one, which means the first T candidates are converted regardless that the first T candidates are uni-motion candidates or bi-motion candidates. If there are no uni-motion candidates in the first T candidates, no conversion is invoked actually. In the second option, for each uni-motion candidate, the value of the index i is incremented by one, which means the first T uni-motion candidates need to be converted, regardless they are successfully converted or not. In the third option 3, the value of the index i is incremented by one only if a uni-candidate is successfully converted to a bi-motion candidate, which can guarantee there are T converted bi-motion candidates in the merge list after conversion.

FIG. 29B is a schematic diagram illustrating an example process 2900B of merge candidate list conversion corresponding to the process 2700A in FIG. 27A, according to some embodiments of the present disclosure. FIG. 29B gives an example according to the embodiments of FIG. 27A. First, a merge candidate list is constructed with seven candidates 2920-2926, of which candidates 2920, 2923, and 2925 are bi-motion candidates, candidates 2921, 2924, and 2926 are uni-motion candidates with only MV₁ and candidate 2920 is a uni-motion candidate only with MV₀. After conversion, candidates 2921, 2922, and 2926 are successfully converted to bi-motion candidates 2931, 2932, and 2936, but candidate 2924 fails to be converted. Thus, candidate 2921 is replaced with candidate 2931, candidate 2922 is replaced with candidate 2932 and candidate 2926 is replaced with candidate 2936.

In some other embodiments, step 2740 is optional and can be skipped. That is, it is assumed that the converted bi-motion candidate is always good, and the converted bi-motion candidate is used after conversion without checking.

In some other embodiments, the converted bi-motion candidate is not used to replace the current candidate (e.g., the original uni-motion candidate from which this bi-motion candidate is converted), but used to replace the candidates in the last positions. Generally speaking, the less efficient candidates are placed behind the more efficient candidates.

FIG. 27B is a flowchart of an example process 2700B of merge candidate list conversion, according to some embodiments of the present disclosure. As shown in FIG. 27B, compared to the process 2700A in FIG. 27A, if the converted bi-motion candidate is good (step 2740—yes), at step 2752, the original uni-motion candidate is replaced with the converted bi-motion candidate, and the original uni-motion candidate is put into a secondary candidate list. Otherwise (step 2740—no), the original uni-motion candidate is kept in the merge candidate list and the converted bi-motion candidate is put into the secondary candidate list. In some examples, step 2740 is optional, and the converted bi-motion candidates are all put into the secondary candidate list, or the original uni-motion candidates are all replaced with the converted bi-motion candidates and the original uni-motion candidates are all put into the secondary candidate list. After conversion, at step 2780, assuming there are N candidates in the secondary candidate list, the last N candidates in the merge candidate list are replaced with N candidates in the secondary candidate list in order. FIGS. 29C and 29D are schematic diagrams illustrating examples of merge candidate list conversion 2900C and 2900D corresponding to the processes in FIG. 27B, according to some embodiments of the present disclosure.

As shown in the example of FIG. 29C, first, a merge candidate list is constructed with seven candidates 2920-2926, of which candidates 2920, 2923, and 2925 are bi-motion candidates, candidates 2921, 2924, and 2926 are uni-motion candidates with only MV₁ and candidate 2920 is a uni-motion candidate only with MV₀. After conversion, candidates 2921, 2922, and 2926 are successfully converted to bi-motion candidates 2931, 2932, and 2936, but candidate 2924 fails to be converted. Then, bi-motion candidates 2931, 2932, and 2936 are put into the secondary candidate list. Then the last three candidates 2924-2926, are replaced with these three candidates 2931, 2932, and 2936 in the secondary candidate list.

As shown in the example of FIG. 29D, as another example, after conversion, the original uni-motion candidate, candidates 2921, 2922, and 2926 are replaced with the converted bi-motion candidates 2931, 2932, and 2936, and original uni-motion candidates 2921, 2922, and 2926, are put into the secondary candidate list. After that, the last three candidate in the merge candidate list (i.e., candidates 2924, 2925, and 2936) are replaced with these three candidates 2921, 2922, and 2926 in the secondary candidate list.

FIG. 27C is a flowchart of an example process 2700C of merge candidate list conversion, according to some embodiments of the present disclosure. In some other embodiments, the candidates in the secondary candidate list are not used to directly replace the last candidates in the merge candidate list, but they are first compared with the last candidates in the merge candidate list, and replace the last candidates only if the converted candidates are better. The comparison can be realized by reordering. That is, the candidates in the secondary candidate list and the last candidates in the merge candidate list are reordered. Suppose there are N candidates in the secondary candidate list, then these N candidates are reordered with last N candidates in the merge candidate list. And then the first N candidate among these 2N candidates are kept in the last N positions of the merge candidate list.

As shown in FIG. 27C, steps 2710-2770 are the same as the steps 2710-2770 performed in the process 2700B in FIG. 27B. Compared to the process 2700B in FIG. 27B, in the process 2700C, after step 2770, at step 2782, assuming there are N candidates in the secondary candidate list, and there are K candidates in the merge candidate list. The first K-N candidates of the merge candidate list are unchanged. The last N candidates of the merge candidate list are reordered together with the N candidates in the secondary candidate list. After reordering, the first N candidates are obtained from the 2N candidates and used to replace the last N candidates of the merge candidate list.

FIGS. 29E and 29F are schematic diagrams illustrating examples of merge candidate list conversion 2900E and 2900F corresponding to the processes in FIG. 27C, according to some embodiments of the present disclosure.

As shown in FIG. 29E, first, a merge candidate list is constructed with seven candidates 2920-2926, of which candidates 2920, 2923, and 2925 are bi-motion candidates, candidates 2921, 2924, and 2926 are uni-motion candidates with only MV₁ and candidate 2920 is a uni-motion candidate only with MV₀. After conversion, candidates 2921, 2922, and 2926 are successfully converted to bi-motion candidates 2931, 2932, and 2936, but candidate 2924 fails to be converted. Then candidates 2931, 2932, and 2936 are put into the secondary candidate list. Then the last three candidates (i.e., candidates 2924-2926), and these three converted bi-motion candidates (i.e., candidates 2931, 2932, and 2936) are reordered, as shown in the block. The reordering may be according to the candidate index. That is, a candidate with a less index is placed before a candidate with a greater index. For two candidates with same index, depending on whether the converted candidate is a good candidate, the original one may be before the converted one or after the converted one. Thus, after the reordering, the candidates are in the order of candidates 2931, 2932, 2924, 2925, 2926 and 2936 (assume the original candidate is better than the converted candidate). So, the first three of these six candidates (i.e., candidates 2931, 2932, 2924) are kept in the merge candidate list as the last three candidates.

As shown in FIG. 29F, in another example, after conversion, the original uni-motion candidate, candidates 2921, 2922, and 2926, are replaced with the converted bi-motion candidate 2931, 2932, and 2936, and original uni-motion candidates 2921, 2922, and 2926, are put into the secondary candidate list. After that, the last three candidate in the merge candidate list (i.e., candidates 2925, 2925, and 2936) and those three candidates in the secondary candidate list (i.e., candidates 2921, 2922, and 2926), are reordered, as shown in block. The reordering may be according to the candidate index. That is, a candidate with the less index is placed before a candidate with the greater index. For two candidates with same index, depending on whether the converted candidate is a good candidate, the converted one may be before the original one or after the original one. Thus, after the reordering, the candidates are in the order of candidates 2921, 2922, 2924, 2925, 2936 and 2926 (assume the converted candidate is better than the original candidate). So, the first three of these six candidates (i.e., candidates 2921, 2922, 2924) are kept in the merge candidate list as the last three candidates.

FIG. 27D is a flowchart of an example process 2700D of merge candidate list conversion, according to some embodiments of the present disclosure. In some embodiments, the converted bi-motion candidate is not used as a replacement for the original uni-motion candidate, but as an additional candidate to be added into the merge list. As shown in FIG. 27D, steps 2710-2740 are the same or similar to those performed in the process 2700A-2700C in FIGS. 27A-27C. Compared to the process 2700A-2700C, if the converted bi-motion candidates are determined to be good, at step 2754, the converted bi-motion candidates are put into a secondary candidates list. After all the uni-motion are converted and checked (step 2770—yes), at step 2784, the converted bi-motion candidates in the secondary candidate list are added to the merge candidate list. Then, at step 2786, all candidates in the merge list are reordered. In some embodiments, the method of ARMC can be used. That is, the candidates can be reordered based on TM cost. The TM cost is calculated as the SAD or SATD between the L-shape template of the predicted block referred to by the motion candidate and the template of the current the block.

The candidates with less TM cost are placed before the candidate with greater TM cost. After reordering, the first N candidate is kept and the remaining candidates are removed to keep the candidate merge list length equal to N, where N is the candidate number in the original merge candidate list. N can be configured by the encoder and signaled in the bitstream.

FIG. 29G is a schematic diagram illustrating an example of merge candidate list conversion 2900G corresponding to the processes in FIG. 27D, according to some embodiments of the present disclosure. First, a merge candidate list is constructed with seven candidates 2920-2926, of which candidates 2920, 2923, and 2925 are bi-motion candidates, candidates 2921, 2924, and 2926 are uni-motion candidates with only MV₁ and candidate 2920 is a uni-motion candidate only with MV₀. After conversion, candidates 2921, 2922, and 2926 are successfully converted to bi-motion candidates 2931, 2932, and 2936 and added into a secondary candidate list. Next, these three candidates (i.e., candidates 2931, 2932, and 2936) are added into merge candidate list and reorder with other candidates (i.e., candidates 2920-2926). After the reordering, the candidates are in the order of candidates 2922, 2921, 2931, 2926, 2923, 2936, 2920, 2925, 2932, and 2924. Finally, the first seven candidates are kept in the merge candidate list and the other candidates are removed. That is, after conversion, the candidates contained in the merge candidate list are candidates 2922, 2921, 2931, 2926, 2923, 2936, 2920.

In some embodiments, the conversion process is applied at the stage of DMVR, but not right after the merge candidate list is constructed. So, after merge candidate list is constructed, adaptive reordering of merge candidate (ARMC) is performed first. Then, during the DMVR stage, for bi-motion candidate, the current DMVR is applied; for uni-motion candidate, the conversion process is applied based on decoder side motion search. After conversion, the TM based refinement may or may not be applied to the converted bi-motion candidate.

Since the conversion process is applied after ARMC, the decoder only needs to perform the conversion process for the candidate selected by the encoder, but does not need to perform conversion process for the other candidates in the merge candidate list. That is, if the candidate indicated by the candidate index is a uni-motion candidate, the conversion process is invoked for this uni-motion candidate only in the decoder; otherwise, the conversion process is not invoked. In some embodiments, the conversion process needs to be performed on the all the uni-motion candidates in the merge candidate list. Thus, the complexity is reduced significantly in this embodiment.

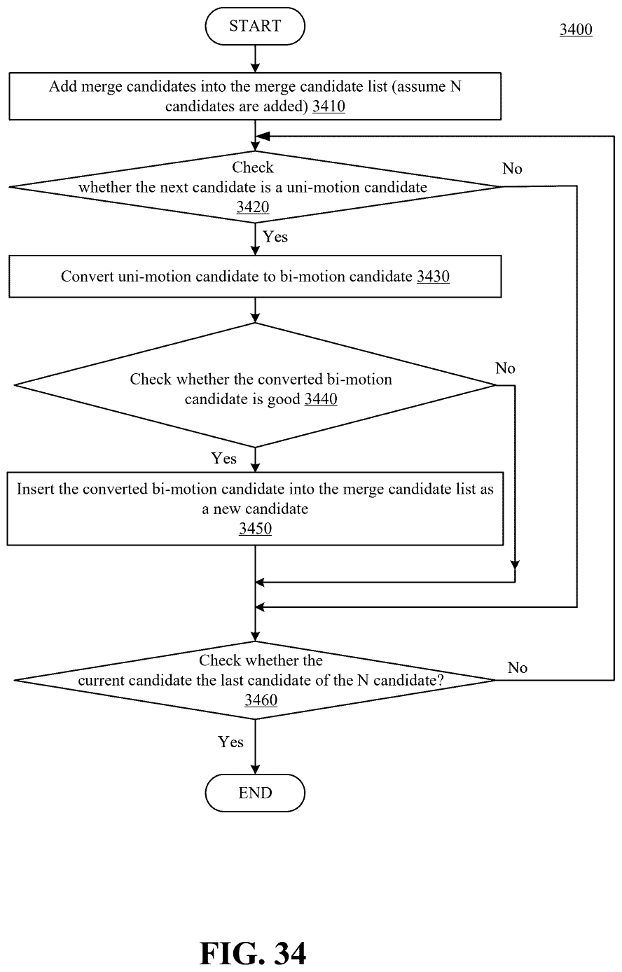

FIG. 33 is a flowchart of an example merge candidate conversion process 3300, according to some embodiments of the present disclosure. As shown in the flowchart in FIG. 33, after decoding the merge candidate list is constructed and candidate index is decoded from the bitstream, at step 3310, the candidate indicated by the candidate index is determined.

Then, at step 3320, whether the candidate indicated by the candidate index is a uni-motion candidate is determined. Then, if it is the bi-motion candidate (step 3320—no), at step 3330, the bi-motion refinement, such as DMVR, TM refinement for bi-prediction, etc., can be performed. If it is the uni-motion candidate (step 3320—yes), the conversion process at step 3340 is invoked to convert it to a bi-motion candidate. The conversion process at step 3340 may be the same as those discussed in other embodiments. Any conversion processes described in other embodiments, such as the methods shown in FIG. 28, FIG. 30, and FIG. 31, can be applied.

After conversion, as shown in FIG. 33, at step 3350, a comparison is performed to determine whether to keep the converted bi-motion candidate or revert to the original uni-motion candidate. If the converted bi-motion is better than the original uni-motion (step 3350—yes), at step 3360, the current candidate is updated to the bi-motion candidate with the converted bi-motion. Otherwise (step 3350—no), the current candidate is kept as the uni-motion candidate with the original uni-motion. After the conversion process 3300, other coding tools such as TM based refinement or BDOF can be applied to the motion candidate.

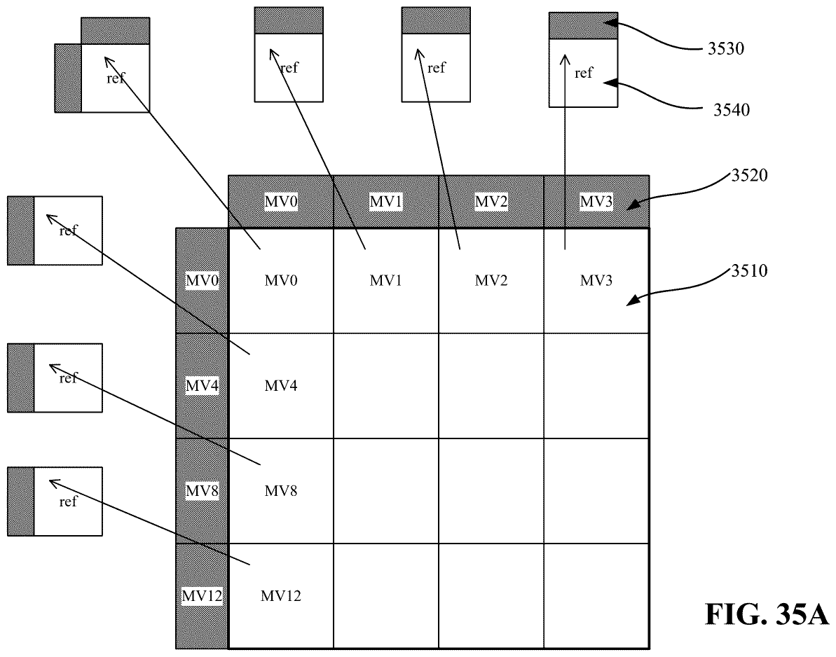

FIG. 34 is a flowchart of an example process 3400 of merge candidate list conversion, according to some embodiments of the present disclosure. In some embodiments, the conversion can be applied during the construction of the merge list. After some candidates are added into the merge list, the conversion is applied on the candidates which are already in the merge list and after conversion, the converted candidates are added into the merge list as new candidates. As shown in FIG. 34, at step 3410, first, the current existing merge candidates, such as spatial candidates, temporal candidate's, non-adjacent spatial candidate, history-based candidates, pair-wise candidates can be inserted into the merge candidate list. That is, merge candidates are added into the merge candidate list (assume N candidates are added). Then, at step 3420, a next candidate in the merge candidate list becomes a current candidate (denoted as Cand_{c}) and is checked whether the candidate is a uni-motion candidate.

If the current candidate is a uni-motion candidate (step 3420—yes), the conversion process including steps 3430-3450 is invoked. Otherwise (step 3420—no), steps 3430-3450 are skipped, and step 3460 is performed. At step 3430, for each of the candidates added in the merge candidate list, if it is a uni-motion candidate, the conversion process is applied to obtain the bi-motion candidate (denoted as Cand_{cb}). The conversion process can be based on BM, and all the conversion methods described above in other embodiments can be used in step 3430. After the conversion process at step 3430, at step 3440, a comparison is performed to determine whether keep the converted bi-motion candidate. At steps 3440 and 3450, whether to insert the bi-motion candidate into the merge candidate list can be determined by checking whether the converted bi-motion candidate is good. All the check methods described in the other embodiments (e.g., as shown in FIGS. 27A-27D) can be used. In some other embodiments, step 3440 can be skipped. That is, the converted bi-motion candidates are always treated as good candidates. Then, if the converted bi-motion candidate is good (step 3740—yes), at step 3450, it is added into the merge candidate list after those candidates already in the merge candidate list, as a new candidate. Otherwise (step 3740—no), step 3450 is skipped and the converted bi-motion candidate is not used.

As shown in FIG. 34, in some embodiments, if the current candidate is not the last candidate (step 3460—no), steps 3420-3450 can be repeated for each of the candidates already in the merge candidate list, until the merge candidate list is full (i.e., the candidate number achieves the maximum number) or all the uni-motion candidates in the merge candidate list are checked and converted (step 3460—yes).

In some embodiments of the present disclosure, methods for the decoder side motion refinement for affine uni-prediction are provided.

In some embodiments, the proposed method can be applied on the regular merge mode and can also be applied to the opposite LIC (local illumination compensation) merge mode and TM merge mode. In these merge modes, the candidate only has translation motion candidate. In addition, the proposed method can also be applied to subblock merge mode. For subblock merge mode, the MV can be derived at subblock level. There are two kinds of candidate in the subblock merge candidate list: subblock TMVP and affine motion candidates.

In some embodiments, the proposed refinement can be applied to the uni-affine motion candidate. When the proposed refinement is applied to the uni-affine motion candidate, all methods for the regular merge candidate can be used.

In the BM based refinement, affine DMVR process can be applied. Because the motion compensation (MC) of affine block is performed on subblock level, the predictor block is also interpolated one sub-block by one-subblock. The BM cost is calculated as the sum of the SADs of all the subblock. For the refinement, both the base MV of the affine model and the non-translation parameters of the affine model can be refined. When the base MV is refined, an offset is added to the base MV. When the non-translation parameters are refined, parameter offsets are added to the non-translation parameters. In some other examples, the BM search can be performed by searching CPMVs. That is, the initial set of CPMVs refers to an initial position, then MV offset is added to all CPMVs to get a surrounding search point. If the surrounding search position produces less BM cost, the CPMVs are updated with the offset according to the following formula:

$$\{ \begin{matrix}CPMV {{0}_{l 0}}^{′} = CPMV {0}_{l 0} + {MV}_{offset} \\ CPMV {{0}_{l 1}}^{′} = CPMV {0}_{l 1} - {MV}_{offset} \\ CPMV {1}_{l 0} = CPMV {1}_{l 0} + {MV}_{offset} \\ CPMV {{1}_{l 1}}^{′} = CPMV {1}_{l 1} - {MV}_{offset} \\ CPMV {{2}_{l 1}}^{′} = CPMV {2}_{l 0} + {MV}_{offset} \\ CPMV {{2}_{l 1}}^{′} = CPMV {2}_{l 1} - {MV}_{offset}\end{matrix} \qquad ( Equation 16 )$$

$$or$$

$$\{ \begin{matrix}CPMV {{0}_{l 0}}^{′} = CPMV {0}_{l 0} + {MV}_{offset} \\ CPMV {{0}_{l 1}}^{′} = CPMV {0}_{l 1} \\ CPMV {1}_{l 0} = CPMV {1}_{l 0} + {MV}_{offset} \\ CPMV {{1}_{l 1}}^{′} = CPMV {1}_{l 1} \\ CPMV {{2}_{l 1}}^{′} = CPMV {2}_{l 0} + {MV}_{offset} \\ CPMV {{2}_{l 1}}^{′} = CPMV {2}_{l 1}\end{matrix} , \qquad ( Equation 17 )$$

wherein CPMViₗ₀ is the i-th original CPMV in uni-motion candidate and CPMViₗ₁ is the i-th converted CPMV, MV_{offset} it the MV offset corresponding to each search position.

After refinement, the TM cost can be used to compare the converted bi-motion and the original uni-motion. As MC is performed at subblock level, the template of reference block also consists of sub-template, each of which is the neighboring area of a reference subblock.

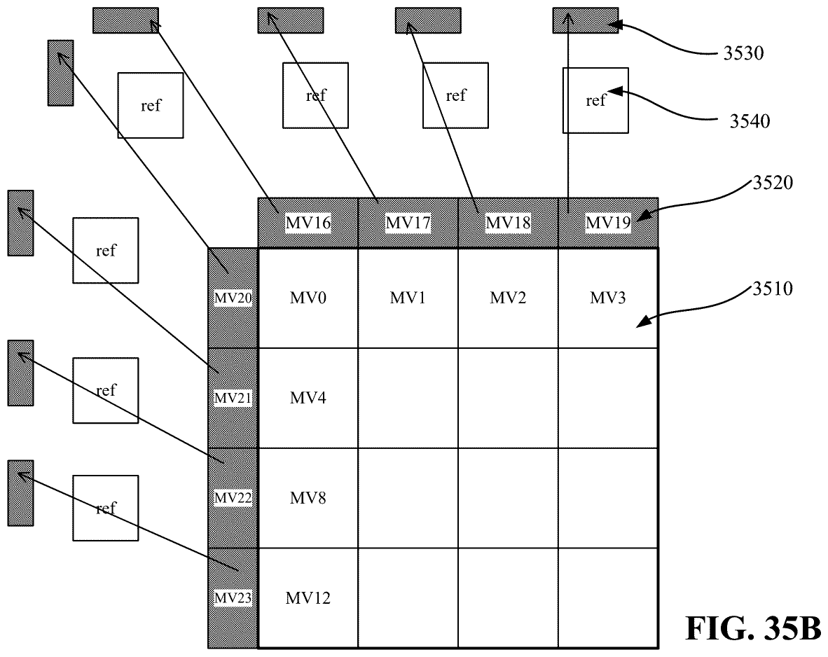

To get the template of the reference block, the MV of each subblock template need to be derived. In one example, the MV of each sub-template is borrowed from the boundary subblock. That is, the MV of a sub-template is the same as the MV of the adjacent subblock within the current coding block. FIG. 35A illustrates MVs of sub-templates of an affine motion codec block, according to some embodiments of the present disclosure. As shown in FIG. 35A, the white subblocks are the subblocks 3510 of the current coding block and the shaded subblocks are the sub-templates 3520. The MV value (i.e., MV0, MV1, MV2, MV3, MV4, MV8 and MV12) of the boundary subblock 3510 is the same as MV of the sub-templates 3520. Thus, the sub-templates 3530 of reference blocks are adjacent to the reference subblocks 3540 which are marked as “ref.”

In some other examples, the MV of sub-template can be derived according to the affine model based on the coordinate of each sub-template. Thus, each sub-template has its own MV which may be different from that of boundary subblock. FIG. 35B illustrates MVs of sub-templates of an affine motion codec block, according to some embodiments of the present disclosure. As shown in FIG. 35B, the boundary subblocks 3510 have MV values marked as MV0, MV1, MV2, MV3, MV4, MV8 and MV12, and the sub-templates 3520 have MV values marked as M16 to MV23. As the sub-template MVs may be different from the boundary subblock MVs, the sub-templates 3530 of the reference block may be separated from reference subblocks 3540.

The conditions of the proposed refinement will be discussed. In some embodiments, to reduce the complexity, the proposed refinement method can be only applied to certain candidate. For example, the proposed refinement can be only applied to a candidate without LIC.

In some embodiments, the proposed refinement depends on quantization parameter, block size, temporal layer. For example, the proposed refinement can be enabled when the quantization parameter is larger than a threshold, or the proposed refinement can be enabled when the quantization parameter is less than a threshold. For another example, the proposed refinement can be enabled when the current block size is larger than a threshold, or the proposed refinement can be enabled when the current block size is less than a threshold. For yet another example, the proposed refinement can be enabled when the current picture is in a high temporal layer.

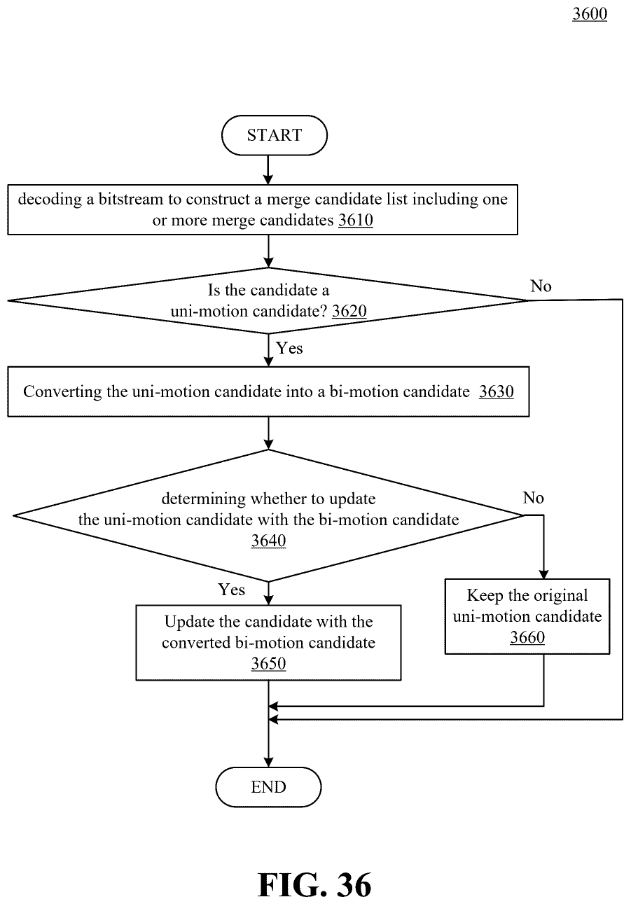

FIG. 36 is a flowchart of an example method 3600 of decoding a bitstream to output one or more pictures for a video stream, according to some embodiments of the present disclosure. In some embodiments, the method 3600 can be performed by a decoder (e.g., decoder 300 in FIG. 3). For example, the decoder can be implemented as one or more software or hardware components of an apparatus (e.g., apparatus 400 in FIG. 4) for decoding the bitstream (e.g., video bitstream 228 in FIG. 3) to reconstruct a video frame or a video sequence (e.g., video stream 304 in FIG. 3) of the bitstream. For example, a processor (e.g., processor 402 in FIG. 4) can perform the method 3600. As shown in FIG. 36, the method 3600 may include steps 3610-3660.

Referring to the method 3600, at step 3610, the decoder decodes a bitstream (e.g., video bitstream 228 in FIG. 3) to construct a merge candidate list including one or more merge candidates. At steps 3620-3660, the decoder performs a motion conversion for a candidate from the merge candidate list. In particular, at step 3620, the decoder determines whether the candidate from the merge candidate list is a uni-motion candidate. In response to the candidate being the uni-motion candidate (step 3620—yes), the decoder may determine a bi-motion candidate based on the first candidate and one or more candidate motion vectors and add the bi-motion candidate to the merge candidate list. For example, at step 3630, the decoder converts the uni-motion candidate into a bi-motion candidate. Then, at step 3640, the decoder determines whether to update the uni-motion candidate with the bi-motion candidate. For example, if the bi-motion candidate is better than the uni-motion candidate (step 3640—yes), at step 3650, the decoder updates the candidate with the converted bi-motion candidate. If the uni-motion candidate is better than the bi-motion candidate (step 3640—no), at step 3660, the conversion is reverted and the decoder keeps the original uni-motion candidate.

In some embodiments, the decoder may determine the bi-motion candidate by determining the first motion vector of the first candidate, obtaining the one or more candidate motion vectors, obtaining one or more motion vector pairs, in which each of the one or more motion vector pairs includes the first motion vector and one of the one or more candidate motion vectors, and selecting one of the one or more motion vector pairs as the bi-motion candidate.

As disclosed in the above various embodiments, the processes of converting the uni-motion candidate into the bi-motion candidate in step 3620 can be achieved by various methods. For example, as shown in the embodiments of FIG. 28 and FIG. 30, step 3620 may include the operations of determining a first motion vector (e.g., MVₖ) of the uni-motion candidate (e.g., step 2810 in FIG. 28 or step 3010 in FIG. 30), obtaining one or more candidate motion vectors (e.g., MV_{1-k,i} or MV_{1-k,j}) (e.g., step 2820 in FIG. 28 or step 3020 in FIG. 30), obtaining one or more refined motion vector pairs (e.g., MVₖ′ and MV_{1-k,i}′ or MVₖ′ and MV_{1-k,j}′) and corresponding one or more BM costs by, for each candidate motion vector, performing a BM based refinement based on a corresponding motion vector pair including the first motion vector and the candidate motion vector (e.g., steps 2830 and 2840 in FIG. 28 or steps 3030 and 3040 in FIG. 30), and selecting one of the one or more refined motion vector pairs as the bi-motion candidate based on the corresponding one or more BM costs (e.g., step 2850 in FIG. 28 or step 3050 in FIG. 30).

As shown in the embodiments of FIG. 28, in some embodiments, the one or more candidate motion vectors are obtained from another one or more candidates in the merge candidate list. As shown in the embodiments of FIG. 30, in some embodiments, the first motion vector is scaled to one or more references pictures in another reference picture list to obtain the one or more candidate motion vectors.

As shown in the embodiments of FIG. 31, in some embodiments, the one or more candidate motion vectors include one or more first candidate motion vectors (e.g., MV_{1-k,i}) and one or more second candidate motion vectors (e.g., MV_{1-k,j}). The one or more candidate motion vectors are obtained by obtaining the one or more first candidate motion vectors from another one or more candidates in the merge candidate list (e.g., steps 3120-3140 in FIG. 31), and scaling the first motion vector to one or more references pictures in another reference picture list to obtain the one or more second candidate motion vectors (e.g., steps 3150-3170 in FIG. 31).

As shown in the embodiments of FIG. 27, in some embodiments, the motion conversion is performed to each merge candidate in the merge candidate list to obtain an updated merge candidate list.

As shown in the embodiments of FIG. 33, in some other embodiments, the decoder may perform adaptive reordering of merge candidate (ARMC) to reorder the one or more merge candidates in the merge candidate list after the merge candidate list is constructed, decode the bitstream to obtain a candidate index, determine a selected candidate indicated by the candidate index (e.g., step 3310 in FIG. 33), and in response to the selected candidate being the uni-motion candidate, perform the motion conversion for the selected candidate (e.g., steps 3340-3370 in FIG. 33). The decoder may, in response to the selected candidate being the bi-motion candidate, perform bi-motion refinement to the selected candidate. (e.g., step 3330 in FIG. 33).

In some embodiments, the decoder may determine whether to perform the motion conversion for the candidate from the merge candidate list according to a quantization parameter, a block size, a temporal layer, or any combination thereof. In some other embodiments, the decoder may disable the motion conversion for the candidate in response to the candidate with local illumination compensation (LIC).

In some embodiments, the decoder may add the bi-motion candidate at an end of the merge candidate list. In some other embodiments, the decoder may replace a second candidate different from the first candidate in the merge candidate list with the bi-motion candidate. The second candidate is after the first candidate in the merge candidate list. In yet some other embodiments, the decoder may replace the first candidate with the bi-motion candidate.

In some embodiments, the decoder may, in response to the number of the bi-motion candidates added into the merge candidate list being less than a threshold, determine the bi-motion candidate based on the first candidate and add the bi-motion candidate to the merge candidate list. In some embodiments, the decoder may, determine whether a second candidate from the merge candidate list is a uni-motion candidate and the difference between the second candidate and the first candidate is less than a threshold, and, in response to the second candidate being a uni-motion candidate and the difference between the second candidate and the first candidate being less than a threshold, determine the bi-motion candidate based on the first candidate.

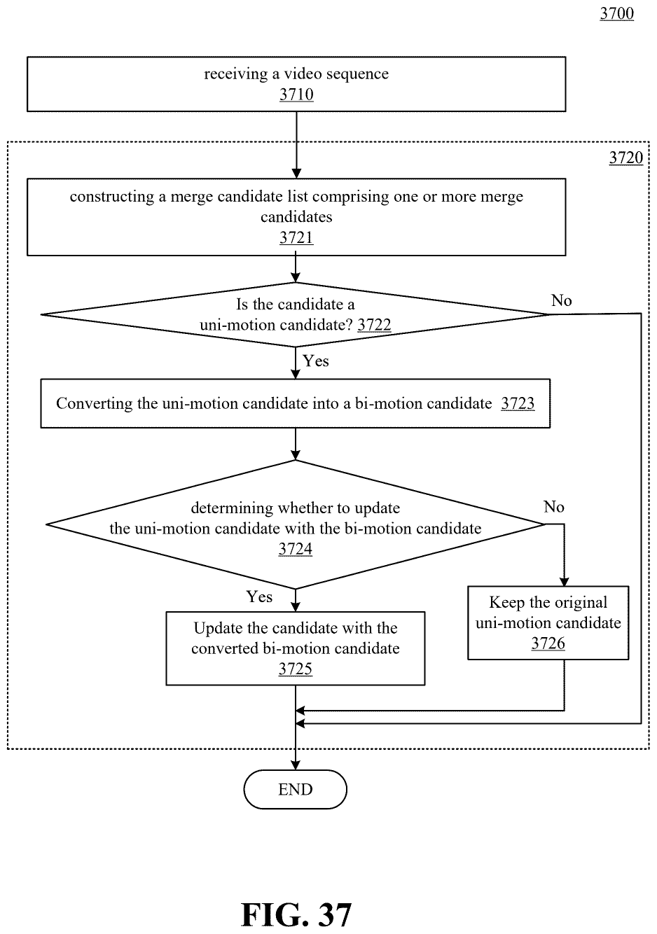

FIG. 37 is a flowchart for an example method 3700 of encoding a video sequence into a bitstream, according to some embodiments of the present disclosure. The method 3700 can be performed by an encoder (e.g., encoder 200 in FIG. 2) to encode a video bitstream. For example, the encoder can be implemented as one or more software or hardware components of an apparatus (e.g., apparatus 400 in FIG. 4) for encoding the bitstream (e.g., video bitstream 228 in FIG. 2) for reconstructing a video frame or a video sequence. For example, a processor (e.g., processor 402 in FIG. 4) can perform the method 3700. As shown in FIG. 37, the method 3700 includes the following steps 3710, and 3721-3726.

At step 3710, the encoder receives a video sequence (e.g., video sequence 202 in FIG. 2). At step 3720, the encoder encodes one or more pictures of the video sequence to generate a bitstream (e.g., video bitstream 228 in FIG. 2). In particular, the encoding step 3720 includes steps 3721-3726. At step 3721, the encoder constructs a merge candidate list including one or more merge candidates. At steps 3722-3726, the encoder performs a motion conversion for a candidate from the merge candidate list. Specifically, at step 3722, the encoder determines whether the candidate from the merge candidate list is a uni-motion candidate. In response to the candidate being the uni-motion candidate (step 3722—yes), the encoder may determine a bi-motion candidate based on the first candidate and one or more candidate motion vectors and add the bi-motion candidate to the merge candidate list. For example, at step 3723, the encoder converts the uni-motion candidate into a bi-motion candidate, and at step 3724, the encoder determines whether to update the uni-motion candidate with the bi-motion candidate. Similar to the operations in the method 3600, if the bi-motion candidate is better than the uni-motion candidate (step 3724—yes), at step 3725, the encoder updates the candidate with the converted bi-motion candidate. If the uni-motion candidate is better than the bi-motion candidate (step 3724—no), at step 3726, the conversion is reverted and the encoder keeps the original uni-motion candidate.

In some embodiments, the encoder may determine the bi-motion candidate by determining the first motion vector of the first candidate, obtaining the one or more candidate motion vectors, obtaining one or more motion vector pairs, in which each of the one or more motion vector pairs includes the first motion vector and one of the one or more candidate motion vectors, and selecting one of the one or more motion vector pairs as the bi-motion candidate.

As disclosed in the above various embodiments, the processes of converting the uni-motion candidate into the bi-motion candidate in step 3723 can be achieved by various methods, as shown in the embodiments of FIG. 28, FIG. 30 and FIG. 31. Detailed operations of step 3723 are similar or the same as those in step 3630 of the method 3600 in FIG. 36, and thus are not repeated herein for the sake of brevity. In some embodiments, in the method 3700, the encoder may select the candidate from the merge candidate list, and encode a candidate index in the bitstream for indicating the selected candidate.

Similarly, in some embodiments, the encoder may add the bi-motion candidate at an end of the merge candidate list. In some other embodiments, the encoder may replace a second candidate different from the first candidate in the merge candidate list with the bi-motion candidate. The second candidate is after the first candidate in the merge candidate list. In yet some other embodiments, the encoder may replace the first candidate with the bi-motion candidate.

In some embodiments, the encoder may, in response to the number of the bi-motion candidates added into the merge candidate list being less than a threshold, determine the bi-motion candidate based on the first candidate and add the bi-motion candidate to the merge candidate list. In some embodiments, the encoder may, determine whether a second candidate from the merge candidate list is a uni-motion candidate and the difference between the second candidate and the first candidate is less than a threshold, and, in response to the second candidate being a uni-motion candidate and the difference between the second candidate and the first candidate being less than a threshold, determine the bi-motion candidate based on the first candidate.

The embodiments described in the present disclosure can be freely combined.

In some embodiments, a non-transitory computer-readable storage medium storing a bitstream is also provided. The bitstream can be encoded and decoded according to the disclosed methods for decoder side motion refinement for uni-prediction.

In some embodiments, a method for storing a bitstream includes operations of: constructing a merge candidate list including one or more merge candidates, updating the constructed merge candidate list, generating a bitstream including coded information of the updated merge candidate list, and storing the bitstream in a non-transitory computer-readable medium. The operations of updating the constructed merge candidate list include determining whether a candidate from the constructed merge candidate list is a uni-motion candidate, and in response to the candidate being the uni-motion candidate, converting the uni-motion candidate into a bi-motion candidate and determining whether to update the uni-motion candidate with the bi-motion candidate. Details of the operations of updating the constructed merge candidate list are similar or the same as those in the method 3600 in FIG. 36 and the method 3700 in FIG. 37, and thus are not repeated herein for the sake of brevity.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:

1. A method of decoding a bitstream to output one or more pictures for a video stream, the method comprising:
decoding a bitstream to construct a merge candidate list comprising one or more merge candidates;
determining whether a first candidate from the merge candidate list is a uni-motion candidate;
in response to the first candidate being the uni-motion candidate, determining a bi-motion candidate based on the first candidate and one or more candidate motion vectors; and
adding the bi-motion candidate to the merge candidate list.

2. The method according to clause 1, wherein determining the bi-motion candidate comprises:
determining a first motion vector of the first candidate;
obtaining the one or more candidate motion vectors;
obtaining one or more motion vector pairs, wherein each of the one or more motion vector pairs comprises the first motion vector and one of the one or more candidate motion vectors; and
selecting one of the one or more motion vector pairs as the bi-motion candidate.

3. The method according to clause 1 or 2, wherein determining the bi-motion candidate comprises:
determining a first motion vector of the uni-motion candidate;
obtaining the one or more candidate motion vectors;
obtaining one or more refined motion vector pairs and corresponding one or more bilateral matching (BM) costs by, for each candidate motion vector, performing a BM based refinement based on a corresponding motion vector pair comprising the first motion vector and the candidate motion vector; and
selecting one of the one or more refined motion vector pairs as the bi-motion candidate based on the corresponding one or more BM costs.

4. The method according to any of clauses 1-3, wherein the one or more candidate motion vectors are obtained by:
obtaining the one or more candidate motion vectors from another one or more candidates in the merge candidate list.

5. The method according to any of clauses 1-4, wherein the one or more candidate motion vectors are obtained by:
scaling a first motion vector to one or more references pictures in another reference picture list to obtain the one or more candidate motion vectors.

6. The method according to any of clauses 1-5, wherein adding the bi-motion candidate to the merge candidate list comprises:
adding the bi-motion candidate at an end of the merge candidate list.

7. The method according to any of clauses 1-6, wherein adding the bi-motion candidate to the merge candidate list comprises:
replacing a second candidate different from the first candidate in the merge candidate list with the bi-motion candidate, wherein the second candidate is after the first candidate in the merge candidate list.

8. The method according to any of clauses 1-7, wherein adding the bi-motion candidate to the merge candidate list comprises:
replacing the first candidate with the bi-motion candidate.

9. The method according to any of clauses 1-8, further comprising:
in response to a number of bi-motion candidates added into the merge candidate list being less than a threshold, determining the bi-motion candidate based on the first candidate and adding the bi-motion candidate to the merge candidate list.

10. The method according to any of clauses 1-9, further comprising:
determining whether a second candidate from the merge candidate list is a uni-motion candidate and a difference between the second candidate and the first candidate is less than a threshold; and
in response to the second candidate being the uni-motion candidate and the difference between the second candidate and the first candidate being less than a threshold, determining the bi-motion candidate based on the first candidate.

11. A method of encoding a video sequence into a bitstream, the method comprising:
receiving a video sequence; and
encoding one or more pictures of the video sequence to generate a bitstream, wherein the encoding comprises:
   constructing a merge candidate list comprising one or more merge candidates;
   determining whether a first candidate from the merge candidate list is a uni-motion candidate; and
   in response to the candidate being the uni-motion candidate, determining a bi-motion candidate based on the first candidate and one or more candidate motion vectors; and
   adding the bi-motion candidate to the merge candidate list.

12. The method according to clause 11, wherein determining the bi-motion candidate comprises:
determining a first motion vector of the first candidate;
obtaining the one or more candidate motion vectors;
obtaining one or more motion vector pairs, wherein each of the one or more motion vector pairs comprises the first motion vector and one of the one or more candidate motion vectors; and
selecting one of the one or more motion vector pairs as the bi-motion candidate.

13. The method according to clause 11 or 12, determining the bi-motion candidate comprises:
determining a first motion vector of the uni-motion candidate;
obtaining the one or more candidate motion vectors;
obtaining one or more refined motion vector pairs and corresponding one or more bilateral matching (BM) costs by, for each candidate motion vector, performing a BM based refinement based on a corresponding motion vector pair comprising the first motion vector and the candidate motion vector; and
selecting one of the one or more refined motion vector pairs as the bi-motion candidate based on the corresponding one or more BM costs.

14. The method according to any of clauses 11-13, wherein the one or more candidate motion vectors are obtained by:
obtaining the one or more candidate motion vectors from another one or more candidates in the merge candidate list.

15. The method according to any of clauses 11-14, wherein the one or more candidate motion vectors are obtained by:
scaling a first motion vector to one or more references pictures in another reference picture list to obtain the one or more candidate motion vectors.

16. The method according to any of clauses 11-15, wherein adding the bi-motion candidate to the merge candidate list comprises:
adding the bi-motion candidate at an end of the merge candidate list.

17. The method according to any of clauses 11-16, wherein adding the bi-motion candidate to the merge candidate list comprises:
replacing a second candidate different from the first candidate in the merge candidate list with the bi-motion candidate, wherein the second candidate is after the first candidate in the merge candidate list.

18. The method according to any of clauses 11-17, wherein adding the bi-motion candidate to the merge candidate list comprises:
replacing the first candidate with the bi-motion candidate.

19. The method according to any of clauses 11-18, further comprising:
in response to a number of bi-motion candidates added into the merge candidate list being less than a threshold, determining the bi-motion candidate based on the first candidate and adding the bi-motion candidate to the merge candidate list.

20. A method for storing a bitstream, comprising:
constructing a merge candidate list comprising one or more merge candidates;
updating the constructed merge candidate list;
generating a bitstream comprising coded information of the updated merge candidate list; and
storing the bitstream in a non-transitory computer-readable medium,
wherein the updating the constructed merge candidate list comprises:
   determining whether a first candidate from the constructed merge candidate list is a uni-motion candidate;
   in response to the candidate being the uni-motion candidate, determining a bi-motion candidate based on the first candidate and one or more candidate motion vectors; and
   adding the bi-motion candidate to the merge candidate list.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed example embodiments. However, many variations and modifications can be made to these embodiments. Accordingly, although specific terms are employed, they are used in a generic and descriptive sense only and not for purposes of limitation.

What is claimed is:

1. A method of decoding a bitstream to output one or more pictures for a video stream, the method comprising:
decoding a bitstream to construct a merge candidate list comprising one or more merge candidates;
determining whether a first candidate from the merge candidate list is a uni-motion candidate;
in response to the first candidate being the uni-motion candidate, determining a bi-motion candidate based on the first candidate and one or more candidate motion vectors; and
adding the bi-motion candidate to the merge candidate list.

2. The method according to claim 1, wherein determining the bi-motion candidate comprises:
determining a first motion vector of the first candidate;
obtaining the one or more candidate motion vectors;
obtaining one or more motion vector pairs, wherein each of the one or more motion vector pairs comprises the first motion vector and one of the one or more candidate motion vectors; and
selecting one of the one or more motion vector pairs as the bi-motion candidate.

3. The method according to claim 1, wherein determining the bi-motion candidate comprises:
determining a first motion vector of the uni-motion candidate;
obtaining the one or more candidate motion vectors;
obtaining one or more refined motion vector pairs and corresponding one or more bilateral matching (BM) costs by, for each candidate motion vector, performing a BM based refinement based on a corresponding motion vector pair comprising the first motion vector and the candidate motion vector; and
selecting one of the one or more refined motion vector pairs as the bi-motion candidate based on the corresponding one or more BM costs.

4. The method according to claim 1, wherein the one or more candidate motion vectors are obtained by:
obtaining the one or more candidate motion vectors from another one or more candidates in the merge candidate list.

5. The method according to claim 1, wherein the one or more candidate motion vectors are obtained by:
scaling a first motion vector to one or more references pictures in another reference picture list to obtain the one or more candidate motion vectors.

6. The method according to claim 1, wherein adding the bi-motion candidate to the merge candidate list comprises:
adding the bi-motion candidate at an end of the merge candidate list.

7. The method according to claim 1, wherein adding the bi-motion candidate to the merge candidate list comprises:
replacing a second candidate different from the first candidate in the merge candidate list with the bi-motion candidate, wherein the second candidate is after the first candidate in the merge candidate list.

8. The method according to claim 1, wherein adding the bi-motion candidate to the merge candidate list comprises:
replacing the first candidate with the bi-motion candidate.

9. The method according to claim 1, further comprising:
in response to a number of bi-motion candidates added into the merge candidate list being less than a threshold, determining the bi-motion candidate based on the first candidate and adding the bi-motion candidate to the merge candidate list.

10. The method according to claim 1, further comprising:
determining whether a second candidate from the merge candidate list is a uni-motion candidate and a difference between the second candidate and the first candidate is less than a threshold; and
in response to the second candidate being the uni-motion candidate and the difference between the second candidate and the first candidate being less than a threshold, determining the bi-motion candidate based on the first candidate.

11. A method of encoding a video sequence into a bitstream, the method comprising:
receiving a video sequence; and
encoding one or more pictures of the video sequence to generate a bitstream, wherein the encoding comprises:
constructing a merge candidate list comprising one or more merge candidates;
determining whether a first candidate from the merge candidate list is a uni-motion candidate; and
in response to the candidate being the uni-motion candidate, determining a bi-motion candidate based on the first candidate and one or more candidate motion vectors; and
adding the bi-motion candidate to the merge candidate list.

12. The method according to claim 11, wherein determining the bi-motion candidate comprises:
determining a first motion vector of the first candidate;
obtaining the one or more candidate motion vectors;
obtaining one or more motion vector pairs, wherein each of the one or more motion vector pairs comprises the first motion vector and one of the one or more candidate motion vectors; and
selecting one of the one or more motion vector pairs as the bi-motion candidate.

13. The method according to claim 11, determining the bi-motion candidate comprises:
determining a first motion vector of the uni-motion candidate;
obtaining the one or more candidate motion vectors;
obtaining one or more refined motion vector pairs and corresponding one or more bilateral matching (BM) costs by, for each candidate motion vector, performing a BM based refinement based on a corresponding motion vector pair comprising the first motion vector and the candidate motion vector; and
selecting one of the one or more refined motion vector pairs as the bi-motion candidate based on the corresponding one or more BM costs.

14. The method according to claim 11, wherein the one or more candidate motion vectors are obtained by:
obtaining the one or more candidate motion vectors from another one or more candidates in the merge candidate list.

15. The method according to claim 11, wherein the one or more candidate motion vectors are obtained by:
scaling a first motion vector to one or more references pictures in another reference picture list to obtain the one or more candidate motion vectors.

16. The method according to claim 11, wherein adding the bi-motion candidate to the merge candidate list comprises:
adding the bi-motion candidate at an end of the merge candidate list.

17. The method according to claim 11, wherein adding the bi-motion candidate to the merge candidate list comprises:
replacing a second candidate different from the first candidate in the merge candidate list with the bi-motion candidate, wherein the second candidate is after the first candidate in the merge candidate list.

18. The method according to claim 11, wherein adding the bi-motion candidate to the merge candidate list comprises:
replacing the first candidate with the bi-motion candidate.

19. The method according to claim 11, further comprising:
in response to a number of bi-motion candidates added into the merge candidate list being less than a threshold, determining the bi-motion candidate based on the first candidate and adding the bi-motion candidate to the merge candidate list.

20. A method for storing a bitstream, comprising:
constructing a merge candidate list comprising one or more merge candidates;
updating the constructed merge candidate list;
generating a bitstream comprising coded information of the updated merge candidate list; and
storing the bitstream in a non-transitory computer-readable medium,
wherein the updating the constructed merge candidate list comprises:
determining whether a first candidate from the constructed merge candidate list is a uni-motion candidate;
in response to the candidate being the uni-motion candidate, determining a bi-motion candidate based on the first candidate and one or more candidate motion vectors; and
adding the bi-motion candidate to the merge candidate list.
